(19) United States
(12) Patent Application Publication
(10) Pub. No.: US 2014/0063056 A1
(43) Pub. Date: Mar. 6, 2014

(54) APPARATUS, SYSTEM AND METHOD FOR VIRTUALLY FITTING WEARABLE ITEMS

(71) Applicant: Jixiong ZHONG, Pingxiang City (CN)

(72) Inventor: Jixiong ZHONG, Pingxiang City (CN)

(73) Assignee: KOSKAR INC., Hanson, KY (US)

(21) Appl. No.: 13/598,563

(22) Filed: Aug. 29, 2012

(51) Int. Cl. G09G 5/00

(52) U.S. Cl. 345/633

(57) ABSTRACT

Provided herein are systems, apparatuses, methods and computer program products for virtually and interactively fitting at least one wearable item on a user.

### FIELD OF THE INVENTION

This invention relates to methods, apparatuses and systems for virtually fitting at least one wearable item on an end user such as a customer or shopper.

### BACKGROUND OF THE INVENTION

Shopping for wearable items in retail stores can be time-consuming, inconvenient and costly, for both consumers and store owners.

Consumers often find it inconvenient to try on multiple items. Frequently, even after spending a long time in multiple retail stores, a customer may still fail to find a desired wearable item that has the right size or color. Online shopping provides a certain degree of convenience: it seems to eliminate multiple trips to retail stores. However, it sometimes can be hard to select the correct size, style and color based on online photos and a customer sometimes ends up returning most if not all the purchased wearable items, which can be time-consuming, costly, and inconvenient (e.g., having to return to the stores or repackaging the purchased items and going to the post-office).

For store owners, it is costly to keep large selections of wearable items with many sizes and colors because the costs in space rental and staff hiring can add up quickly. Consequently, the merchandise overhead can be substantial such that an owner may have to increase the price on the merchandise. Crowded stores are not appealing aesthetically and create potential risk of thefts.

For the reasons above, there are needs for better methods, systems, and apparatuses that can allow a customer to virtually fit one or more wearable items.

### SUMMARY OF THE INVENTION

In some aspect, provided herein is a system or an apparatus for virtually and interactively fitting at least one wearable item on a user. The system or apparatus comprises: a) a data input unit comprising a motion sensing device for tracking one or more movements of the user, and an image collecting device for collecting one or more images of the user; b) a data processing unit; and c) a data output unit. In some embodiments, the data processing unit converts the one or more images to generate a representation corresponding to one or more physical attributes of the user, and wherein the data processing unit is capable of fitting a plurality of article coordinates representing the at least one wearable item to the representation corresponding to one or more physical attributes of the user to generate one or more fitted images of the user wearing the at least one wearable item. In some embodiments, the data output unit comprises a display component, and an optional printing component. In some embodiments, the display component displays the one or more fitted images of the user wearing the at least one wearable item and the optional printing component is capable of printing the one or more fitted images on a print medium.

In some embodiments, the motion sensing device also collects a plurality of physical measurements representing the one or more physical attributes of the user. In some embodiments, the plurality of physical measurements is combined with the one or more images to generate the representation corresponding to the one or more physical attributes of the user.

In some embodiments, the physical attributes comprise size, height, body type, shape, and distance from the motion sensing device.

In some embodiments, the motion sensing device is selected from the group consisting of a Microsoft KINECT™ console, an infrared motion sensing device, an optical motion sensing device and combinations thereof.

In some embodiments, the image collecting device is selected from the group consisting of a camera, a digital camera, a web camera, a scanner, and combinations thereof.

In some embodiments, the data input unit further comprises a manual input component that is capable of receiving manual input of additional physical measurements of the user, wherein the additional physical measurements are selected from the group consisting of size, height, weight, shape, body type, and combinations thereof.

In some embodiments, the data processing unit further comprises a content management module for storing information of the at least one wearable items.

In some embodiments, the at least one wearable item is selected from the group consisting of clothes, hats, wigs, eyeglasses, jewelry items, bags, scarves, head bands, shoes, socks, belts, ties, one or more clothes, one or more of hats, wigs, eyeglasses, jewelry items, bags, scarves, head bands, shoes, socks, belts, ties, and combinations thereof.

In some embodiments, the at least one wearable item is selected from the group consisting of one or more clothes, one or more of hats, wigs, eyeglasses, jewelry items, bags, scarves, head bands, shoes, socks, belts, ties, and combinations thereof.

In some embodiments, the jewelry items are selected from the group consisting of earrings, nose rings, necklaces, bracelets, rings and combinations thereof.

In some embodiments, the display component is selected from the group consisting of digital light processing (DLP) displays, plasma display panels (PDPs), liquid crystal displays (LCDs), such as thin film transistor (TFT-LCD) displays and HPA-LCD displays, light-emitting diode (LED) displays, organic light-emitting diode (OLED) displays, electroluminescent displays (ELDs), surface-conduction electron-emitter displays (SEDs), field emission displays (FEDs), liquid crystal on silicon (LCOS or LCoS) displays, and interferometric modulator displays (IMODs), and combinations thereof.

In some embodiments, the system or apparatus further comprises one or more USB ports.

In some embodiments, an optional printing component is connected to the system or apparatus via a USB port.

In another aspect, provided herein is a method for virtually and interactively fitting at least one wearable item on a user. The method comprises the steps of (a) collecting, via an image collecting device, one or more images of the user; (b) tracking, via a motion sensing device, one or more movements of the user; (c) converting, via a data processing unit, the one or more images to generate a representation representing one or more physical attributes of the user; (d) fitting, via the data processing unit, a plurality of article coordinates representing the at least one wearable item to the representation representing one or more physical attributes of the user to generate one or more fitted images of the user wearing the at least one wearable item; and (e) displaying, on a display component, the one or more fitted images of the user wearing the at least one wearable item.

In some embodiments, the method further comprises a step of printing, via a printing component, the one or more fitted images on a print medium.

In some embodiments, the tracking step further comprises collecting, via the motion sensing device, a plurality of physical measurements of the user, where the plurality of physical measurements and the one or more images are combined to generate a representation representing one or more physical attributes of the user.

In some embodiments, the one or more physical attributes comprise size, height, body type, shape, and distance from the motion sensing device.

In some embodiments, the fitting step is performed based on a two anchor-point mechanism.

In some embodiments, the physical attributes comprise size, height, body type, shape, and distance from the motion sensing device.

In some embodiments, the motion sensing device is selected from the group consisting of a Microsoft KINECT™ console, an infrared motion sensing device, and an optical motion sensing device.

In some embodiments, the image collecting device is selected from the group consisting of a camera, a digital camera, a web camera, a scanner, and combinations thereof.

In some embodiments, the method further comprises a step of inputting, via a manual input component, additional physical measurements of the user, where the additional physical measurements are selected from the group consisting of size, height, weight, shape, body type, and combinations thereof.

In some embodiments, the method further comprises a step of sending, to a remote data server, information of the at least one wearable item.

In some embodiments, the method further comprises a step of receiving, from a user, a command for collecting one or more images of the user.

In some embodiments, the method further comprises a step of receiving, from a user, a command for tracking, one or more movements of the user.

In some embodiments, the method further comprises a step of communicating, to a remote data server, a request for information on one or more wearable items.

In some embodiments, the method further comprises a step of receiving, from a remote data server, information on one or more wearable items.

In another aspect, a computer program product that executes commands for performing the method described herein.

In some embodiments, the at least one wearable item is selected from the group consisting of clothes, hats, wigs, eyeglasses, jewelry items, bags, scarves, head bands, shoes, socks, belts, ties, one or more clothes, one or more of hats, wigs, eyeglasses, jewelry items, bags, scarves, head bands, shoes, socks, belts, ties, and combinations thereof.

In some embodiments, the jewelry items are selected from the group consisting of earrings, nose rings, necklaces, bracelets, rings, and combinations thereof.

In some embodiments, the display component is selected from the group consisting of digital light processing (DLP) displays, plasma display panels (PDPs), liquid crystal displays (LCDs), such as thin film transistor (TFT-LCD) displays and HPA-LCD displays, light-emitting diode (LED) displays, organic light-emitting diode (OLED) displays, electroluminescent displays (ELDs), surface-conduction electron-emitter displays (SEDs), field emission displays (FEDs), liquid crystal on silicon (LCOS or LCoS) displays, and interferometric modulator displays (IMODs), and combinations thereof.

### BRIEF DESCRIPTION OF THE DRAWINGS

FIG. 1 depicts an exemplary integrated apparatus for virtually fitting wearable items.

FIGS. 2A through 2C depict an exemplary hardware configuration.

FIGS. 3A and 3B depict an exemplary software configuration.

FIGS. 4A through 4D depict an exemplary process using the integrated apparatus, including data collection, processing, user interface and content management.

FIGS. 5A and 5B depict an exemplary integrated apparatus.

FIGS. 6A through 6G depict exemplary calibration processes.

FIGS. 7A through 7H depict an exemplary virtual fitting process.

FIGS. 8A and 8B depict exemplary embodiments.

FIGS. 9A through 9E depict exemplary user control mechanism.

FIGS. 10A through 10E depict exemplary user interface icons.

FIGS. 11A through 11D depict exemplary virtual fitting processes.

### DETAILED DESCRIPTION OF THE INVENTION

Provided herein are integrated systems, apparatuses and methods for virtually fitting at least one wearable item on an end user, for example, a customer at a clothing store. Previously known methods for virtually fitting clothes via an online interface do not offer an integrated and total solution to both the customers and store owners. See, for example, Chinese Patent Application Nos. CN200610118321.7; CN200810166324.7; and CN201010184994.9, each of which is incorporated by reference herein in its entirety.

The integrated systems, apparatuses and methods disclosed herein offer advantages to both owners of retail stores and individual customers. On one hand, virtual dressing or fitting of wearable items reduces the need for a large inventory, which saves retail space and eliminates the need for additional staff members. It also reduces the risks of theft. In addition, with virtual dressing or fitting, there is no need for the employees to clean up and re-shelf wearable items after each customer. In addition, a virtual dressing/fitting machine can be a marketing tool for retail store owners.

For customers, there is no need to put on and take off wearable items. It is time-saving. The customer can browse unlimited inventories of wearable items, not limited to those available at the store. The virtual dressing or fitting experience is also interactive and more fun. In addition, dressing or fitting of wearable items is a cleaner experience, which is more sanitary and reduces risks of disease.

As provided herein, the term “wearable item” refers to all clothing items and accessories that can be worn physically on a customer. Examples of wearable items include but are not limited to clothes such as shirts, suits, dresses, pants, coats, undergarments, shorts, tops, t-shirts, sweatshirts, sweaters, jackets, windbreakers, uniforms, sportswear, cardigans, down jackets, wedding dresses, dovetails, ancient costumes, traditional opera costumes. Additional examples of wearable items include but are not limited to hats, wigs, glasses, sunglasses, jewelry items (e.g., earrings, nose rings, necklace, bracelets, rings), bags (e.g., totes, purses, shoulder bags and handbags), scarves, head bands, shoes, socks, belts, ties and the like. In some embodiments, the wearable item is free of clothes and includes hat, eyeglass, jewelry item, bag, scarf, head band, shoe, sock, belt or a combination thereof.

In other embodiments, the wearable item is free of clothes. In other embodiments, the wearable item comprises one or more clothes and one or more of hats, wigs, glasses, sunglasses, jewelry items, bags, scarves, head bands, shoes, socks, belts, ties or a combination thereof. In certain embodiments, the jewelry item disclosed herein comprises one or more precious metals, one or more precious gems or stones, one or more artificial gemstones, one or more plastic ornaments, or a combination thereof. Some non-limiting examples of precious metals include gold, silver, platinum, and combinations thereof. Some non-limiting examples of precious gems or stones include diamond, ruby, sapphire, pearl, opal, beryls such as emerald (green), aquamarine (blue), red beryl (red), goshenite (colorless), heliodor (yellow), and morganite (pink), peridot, cat's eye, andalusite, axinite, cassiterite, clinohumite, amber, turquoise, hematite, chrysocolla, tiger's eye, quartz, tourmaline, carnelian, pyrite, sugilite, malachite, rose quartz, snowflake obsidian, ruby, moss agate, amethyst, blue lace agate, lapis lazuli and the like.

In some embodiments, multiple wearable items are combined and fitted on the same user. For example, a user virtually fitted with a dress can selected to try on one or more pieces of jewelry items such as necklace, earrings and bracelet. In some embodiments, a user can select to try on one or more accessories items (e.g., hats, sunglasses and etc.), while being virtually fitted with a clothing item such as dress, shirt, skirt, and etc.

As provided herein, the term “image capturing device” refers to a device that can capture a visual representation of an objection. The visual representation can be colored, grey-scaled, or black and white. The visual representation can be two-dimensional or three-dimensional. Exemplary image capture devices include but are not limited to a camera, a digital camera, a web camera, a scanner.

As provided herein, the term “motion sensing device” refers to any device that can detect and track a movement of an object, such as a trans-locational or rotational movement. An object here includes a physical object as well as a live subject such as a human or an animal. Exemplary motion sensing devices include but are not limited to a Microsoft KINECT™ console, an infrared motion sensing device, an optical motion sensing device, and etc. Any known motion sensors or sensing devices can be used, including but not limited to those disclosed in U.S. Pat. Nos. 7,907,838; 8,141,424; and 8,179,246; each of which is incorporated herein by reference in its entirety.

In some embodiments, the motion sensing device includes an infrared sensor for capturing the body position of a user. In some embodiments, the captured information is represented by multiple dots or skeleton points that represent the position and shape of the user.

In some embodiments, the motion sensing device includes a depth sensor for measuring the distance between the user and the display of the fitting device. In some embodiments, the same sensor measures both the skeleton points and the depth information.

In some embodiments, images captured by the image capturing device and motion sensing device coincides. In some embodiments, image information of wearable items are saved in advanced and then used to fit the user image capture by the image capturing device and/or motion sensing device.

In some embodiments, the depth sensor recognizes the user's height and measures the distance between user and screen to achieve virtual fitting.

In some embodiments, multiple sensors (infrared and/or depth sensors) are used to collect measurements of one or more physical attributes of the user from different orientations and/or angles. In some embodiments, multiple rounds of measurements of one or more physical attributes of the user can be taken to improve accuracy. In some embodiments, the positions of the infrared and/or depth sensors are changed after each round of measurements of one or more physical attributes of the user.

The term “Bluetooth” refers to an industrial specification for wireless personal area networks (PANs). The Bluetooth specifications are developed and licensed by the Bluetooth Special Interest Group. Generally, Bluetooth provides a way to connect and exchange information between devices such as mobile phones, laptops, PCs, printers, digital cameras, and video game consoles over a secure, globally unlicensed short-range radio frequency.

The term “Wi-Fi” refers to the embedded technology of wireless local area networks (WLAN) based on the IEEE 802.11 standard licensed by the Wi-Fi Alliance. Generally, the branding Wi-Fi-CERTIFIED is tested and certified by the Wi-Fi-Alliance. WiFi includes the generic wireless interface of mobile computing devices, such as laptops in LANs. Some non-limiting common uses of Wi-Fi technology include internet and VoIP phone access, gaming, network connectivity for consumer electronics such as laptops in LANs.

As provided herein, the term “display component” refers to any visual presentation device, including but not limited to, digital light processing (DLP) displays, plasma display panels (PDPs), liquid crystal displays (LCDs), such as thin film transistor (TFT-LCD) displays and HPA-LCD displays, light-emitting diode (LED) displays, organic light-emitting diode (OLED) displays, electroluminescent displays (ELDs), surface-conduction electron-emitter displays (SEDs), field emission displays (FEDs), liquid crystal on silicon (LCOS or LCoS) displays, and interferometric modulator displays (IMODs). One or more of the above-mentioned display component may be used as the display component of the integrated systems and apparatuses disclosed herein.

In certain embodiments, the display component is or comprises a digital light processing (DLP) display. The DLP generally comprises a video projector wherein the image is created by microscopically small mirrors laid out in a matrix on a semiconductor chip, known as a Digital Micromirror Device (DMD). Each mirror represents one pixel in the projected image. These mirrors can be repositioned rapidly to reflect light either through the lens or on to a heatsink (“light dump”). The rapid repositioning of the mirrors can allow the DMD to vary the intensity of the light being reflected out through the lens. Any DLP display known to a skilled artisan can be used for the system disclosed herein. In some embodiments, the DLP display is a single-chip DLP projector. In other embodiments, the DLP display is a three-chip DLP projector. In further embodiments, the DLP display comprises a DLP chipset from Texas Instruments of Dallas, Tex., or from Fraunhofer Institute of Dresden, Germany.

In some embodiments, the display component is or comprises a plasma display panel (PDP). The PDP generally comprises many tiny cells located between two panels of glass hold an inert mixture of noble gases (neon and xenon). The gas in the cells is electrically turned into a plasma, which then excites phosphors to emit light. Any PDP known to a skilled artisan can be used for the system disclosed herein.

In certain embodiments, the display component is or comprises a liquid crystal display (LCD). The LCD generally comprises a thin, flat display device made up of a plurality of color or monochrome pixels arrayed in front of a light source or reflector. It generally uses very small amounts of electric power, and is therefore suitable for use in battery-powered electronic devices. Any LCD known to a skilled artisan can be used for the system disclosed herein.

In other embodiments, the display component is or comprises a light-emitting diode (LED) display or panel. The LED display generally comprises a plurality of LED's, each of which independently emits incoherent narrow-spectrum light when electrically biased in the forward direction of the p-n junction. Generally, there are two types of LED panels: conventional, using discrete LEDs, and surface mounted device (SMD) panels. A cluster of red, green, and blue diodes is driven together to form a full-color pixel, usually square in shape. Any LED display known to a skilled artisan can be used for the system disclosed herein.

In certain embodiments, the display component is or comprises an organic light-emitting diode (OLED) display. The OLED display generally comprises a plurality of organic light-emitting diodes. An organic light-emitting diode (OLED) refers to any light-emitting diode (LED) having an emissive electroluminescent layer comprises a film of organic compounds. The electroluminescent layer generally contains a polymer substance that allows suitable organic compounds to be deposited in rows and columns onto a flat carrier to form a matrix of pixels. The matrix of pixels can emit light of different colors. Any OLED display known to a skilled artisan can be used for the system disclosed herein.

In some embodiments, the display component is or comprises an electroluminescent display (ELD). Electroluminescence (EL) is an optical and electrical phenomenon where a material emits light in response to an electric current passed through it, or to a strong electric field. The ELD generally is created by sandwiching a layer of electroluminescent material such as GaAs between two layers of conductors. When current flows, the electroluminescent material emits radiation in the form of visible light. Any ELD known to a skilled artisan can be used for the system disclosed herein.

In other embodiments, the display component is or comprises a surface-conduction electron-emitter display (SED). The SED generally comprises a flat panel display technology that uses surface conduction electron emitters for every individual display pixel. The surface conduction emitter emits electrons that excite a phosphor coating on the display panel. Any SED known to a skilled artisan can be used for the system disclosed herein. In some embodiments, the SED comprises a surface conduction electron emitter from Canon, Tokyo, Japan.

In certain embodiments, the display component is or comprises a field emission display (FED). The FED generally uses a large array of electron emitters comprising fine metal tips or carbon nanotubes, with many positioned behind each phosphor dot in a phosphor coating, to emit electrons through a process known as field emission. The electrons bombard the phosphor coatings to provide visual images. Any FED known to a skilled artisan can be used for the system disclosed herein.

In some embodiments, the display component is or comprises a liquid crystal on silicon (LCOS or LCoS) display. The LCOS display generally is a reflective technology similar to DLP projectors, except that the former uses liquid crystals instead of individual mirrors used in the latter. The liquid crystals may be applied directly to the surface of a silicon chip coated with an aluminized layer, with some type of passivation layer, which is highly reflective. Any LCOS display known to a skilled artisan can be used for the system disclosed herein. In some embodiments, the LCOS display comprises a SXRD chipset from Sony, Tokyo, Japan. In some embodiments, the LCOS display comprises one or more LCOS chips.

In other embodiments, the display component is or comprises a laser TV. The laser TV generally is a video display technology using laser optoelectronics. Optoelectronics refers to the study and application of electronic devices that interact with light wherein light includes invisible forms of radiation such as gamma rays, X-rays, ultraviolet and infrared. Any laser TV known to a skilled artisan can be used for the system disclosed herein.

In certain embodiments, the display component is or comprises an interferometric modulator display (IMOD). Generally, the IMOD uses microscopic mechanical structures that reflect light in a way such that specific wavelengths interfere with each other to create vivid colors, like those of a butterfly's wings. This can produce pure, bright colors using very little power. Any IMOD known to a skilled artisan can be used for the system disclosed herein.

In some embodiments, the display component is or comprises an electronic paper, e-paper or electronic ink. The electronic paper generally is designed to mimic the appearance of regular ink on paper. Unlike a conventional flat panel display, which uses a backlight to illuminate its pixels, electronic paper generally reflects light like ordinary paper and is capable of holding text and images indefinitely without drawing electricity, while allowing the image to be changed later. Unlike traditional displays, electronic paper may be crumpled or bent like traditional paper. Any electronic paper known to a skilled artisan can be used for the system disclosed herein.

### Exemplary Overall Apparatuses, Systems, and Methods

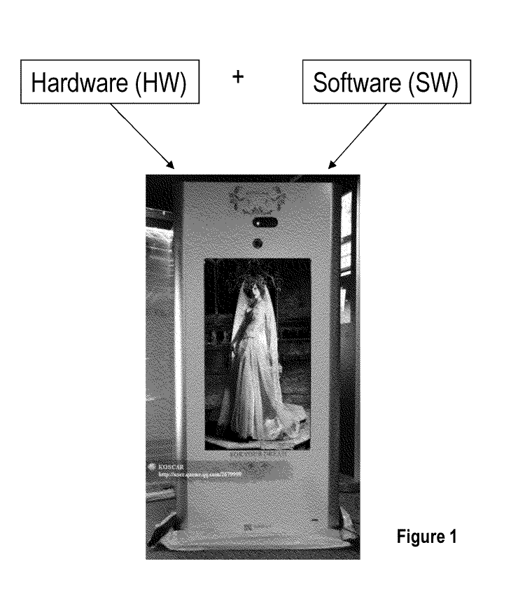

Provided herein are apparatus and systems for virtually fitting wearable items, which apparatus and systems have integrated hardware and software designs. An overview of an exemplary apparatus (e.g., element 100) is illustrated in FIG. 1.

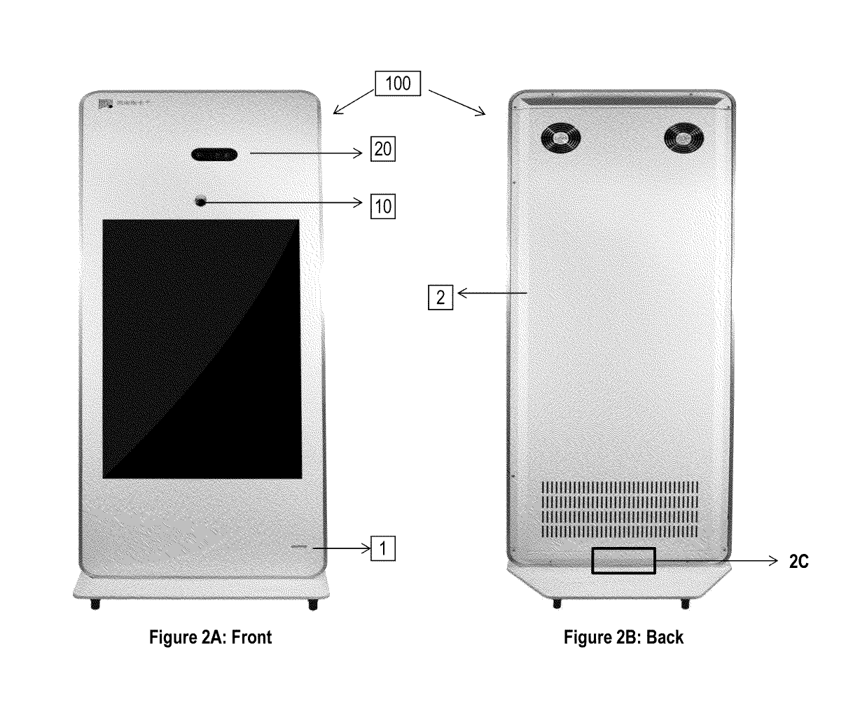

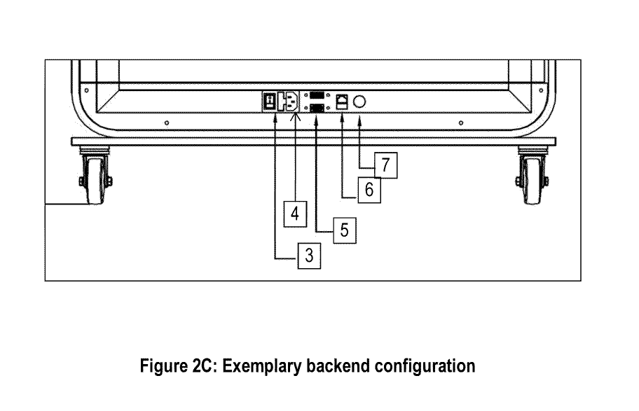

FIGS. 2A-2C depict the front and back views of an exemplary apparatus. Referring to FIG. 2A, an indicator device (e.g., an indicator light shown as element 1) for power and remote receiving end can be found at the front of the apparatus.

In some embodiments, an image collecting device, e.g., element 10, is located in the front of apparatus 100. In some embodiments, image collecting device 10 is a digital camera such as a web camera or a wide angle compact camera. In some embodiments, multiple cameras are used to capture images from different angles. The captured images can be used to construct a 3-dimensional representation of an object or person (such as the entire figure of a customer or end user, or part of the body of a customer such a hand, the face, ears, note or foot of the customer). In some embodiments, the image collecting device is a body scanner that can capture a 2-dimensional or 3-dimensional representation of an object (such as the entire figure of a customer, or part of the body of a customer such a hand, the face, ears, note or foot of the customer).

In some embodiments, image collecting device 10 is positioned at a height from the ground for optimal imagine capture of a user. In some embodiments, the height can be adjusted to match the height of a user. For example, the height of image collecting device will be smaller if children are the main customers. In some embodiments, the height of image collecting device can be 0.2 meter or more, 0.3 meter or more, 0.4 meter or more, 0.5 meter or more, 0.6 meter or more, 0.7 meter or more, 0.8 meter or more, 0.9 meter or more, 1.0 meter or more, 1.1 meters or more, 1.2 meters or more, 1.3 meters or more, 1.4 meters or more, 1.5 meters or more, 1.6 meters or more, 1.7 meters or more, 1.8 meters or more, 1.9 meters or more, 2.0 meter or more, 2.1 meters or more, 2.2 meters or more, or 2.5 meters or more. In some embodiments, the height of the webcam is about 1.4 meter high from the ground to allow good whole body imaging for most users. In some embodiments, the height of image collecting device 10 is adjustable. For example, a webcam can be mounted on a sliding groove such that a user can move the webcam up and down for optimal imaging effects. In some embodiments, the user-interface provides multiple settings such that a user can choose the camera height that best matches the user's height.

In some embodiments, the collection angle of image collecting device 10 can be adjusted for optimal imagine capture of a user. In some embodiments, image collecting device 10 is positioned such that the center of the view field is horizontal or parallel to the ground. In some embodiments, image collecting device 10 is positioned upward or downward at an angle. The angle can be 0.1 degree or wider; 0.2 degree or wider; 0.5 degree or wider; 0.7 degree or wider; 0.8 degree or wider; 1 degree or wider; 1.2 degrees or wider; 1.5 degrees or wider; 2.0 degrees or wider; 2.2 degrees or wider; 2.5 degrees or wider; 2.8 degrees or wider; 3.0 degrees or wider; 3.5 degrees or wider; 4.0 degrees or wider; 5.0 degrees or wider; 6.0 degrees or wider; 7.0 degrees or wider; 8.0 degrees or wider; 9.0 degrees or wider; 10.0 degrees or wider; 12.0 degrees or wider; 15.0 degrees or wider; 20.0 degrees or wider; 25.0 degrees or wider; or 30.0 degrees or wider.

In some embodiments, a motion sensing device 20 is located in the front of apparatus 100. In some embodiments, motional sensing device 20 is a Microsoft KINECT™ console, an infrared motion sensing device, an optical motion sensing device, and etc. In some embodiments, motions are detected and used to provide control over the apparatus and system provided herein. For example, apparatus and system provided herein includes a display unit that includes a touch screen. In some embodiments, changes of motions are used to control the touch screen of the display unit of the apparatus and/or system. Additional information can be found in US Patent Publication Nos. 2012/0162093 and 2010/0053102; U.S. Pat. No. 7,394,451; each of which is incorporated herein by reference in its entirety. In some embodiments, voice control mechanism is used to allow a user to direct the apparatus and/or system. In some embodiments, motion control and voice control mechanisms are combined to allow a user to direct the apparatus and/or system.

In some embodiments, motion sensing device 20 is also positioned at a height from the ground for optimal imagine capture and motion detection of a user. In some embodiments, the height can be adjusted to match the height of a user. For example, the height of image collecting device will be smaller if children are the main customers. In some embodiments, the height of motion sensing device can be 0.2 meter or more, 0.3 meter or more, 0.4 meter or more, 0.5 meter or more, 0.6 meter or more, 0.7 meter or more, 0.8 meter or more, 0.9 meter or more, 1.0 meter or more, 1.1 meters or more, 1.2 meters or more, 1.3 meters or more, 1.4 meters or more, 1.5 meters or more, 1.6 meters or more, 1.7 meters or more, 1.8 meters or more, 1.9 meters or more, 2.0 meter or more, 2.1 meters or more, 2.2 meters or more, or 2.5 meters or more. In some embodiments, the height of the KINECT™ console is about 1.4 meter high from the ground to allow good whole body imaging for most users. In some embodiments, the height of image collecting device 10 is adjustable. For example, a KINECT™ console can be mounted on a sliding groove such that a user can move the webcam up and down for optimal imaging effects. In some embodiments, the user-interface provides multiple settings such that a user can choose the KINECT™ console height that best matches the user's height.

In some embodiments, the collection angle of motion sensing device 20 can be adjusted for optimal imagine capture and motion detection of a user. In some embodiments, motion sensing device 20 is positioned such that the center of the view field is horizontal or parallel to the ground. In some embodiments, motion sensing device 20 is positioned upward or downward at an angle. The angle can be 0.1 degree or wider; 0.2 degree or wider; 0.5 degree or wider; 0.7 degree or wider; 0.8 degree or wider; 1 degree or wider; 1.2 degrees or wider; 1.5 degrees or wider; 2.0 degrees or wider; 2.2 degrees or wider; 2.5 degrees or wider; 2.8 degrees or wider; 3.0 degrees or wider; 3.5 degrees or wider; 4.0 degrees or wider; 5.0 degrees or wider; 6.0 degrees or wider; 7.0 degrees or wider; 8.0 degrees or wider; 9.0 degrees or wider; 10.0 degrees or wider; 12.0 degrees or wider; 15.0 degrees or wider; 20.0 degrees or wider; 25.0 degrees or wider; or 30.0 degrees or wider.

In some embodiments, the relative positions of image collecting device 10 and motion sensing device 20 are adjusted for optimal results. In some embodiments, the center of image collecting device 10 is matched with the center of motion sensing device 20. For example, the center of a webcam is matched with the center of an infrared sensor. In some embodiments, when multiple image collecting devices are used, the organizational center of the multiple devices is matched with the center of motion sensing device 20. For example, two cameras are used and aligned horizontally while the center of the two cameras is matched with the center of an infrared sensor. In some embodiments, the centers of the image collecting device 10 (or devices) and of the motion sensing device 20 are matched perfected. In some embodiments, there may be a difference between the centers of these two types of devices. The difference can be 0.1 mm or less, 0.2 mm or less, 0.5 mm or less, 0.8 mm or less, 1.0 mm or less, 1.25 mm or less, 1.5 mm or less, 2.0 mm or less, 2.5 mm or less, 3.0 mm or less, 4.0 mm or less, 5.0 mm or less, 6.0 mm or less, 7.0 mm or less, 8.0 mm or less, 9.0 mm or less, 10.0 mm or less, 12.0 mm or less, 15.0 mm or less, 17.0 mm or less, 20.0 mm or less, 25.0 mm or less, or 30.0 mm or less.

In some embodiments, image collecting device 10 and motion sensing device 20 are joined or connected to ensure optimal image capture and motion detection.

In some embodiments, the system and/or apparatus is positioned at a distance from a user so that optimal image collection and control can be achieved. It will be understood that the distance may vary based on, for example, the height of the user or where image collecting device 10 and motion sensing device 20 are positioned from the ground. In some embodiments, the system/apparatus is positioned at a distance of about 0.2 m or longer; 0.3 m or longer; 0.4 m or longer; 0.5 m or longer; 0.6 m or longer; 0.7 m or longer; 0.8 m or longer; 0.9 m or longer; 1.0 m or longer; 1.1 m or longer; 1.2 m or longer; 1.3 m or longer; 1.4 m or longer; 1.5 m or longer; 1.6 m or longer; 1.7 m or longer; 1.8 m or longer; 1.9 m or longer; 2.0 m or longer; 2.1 m or longer; 2.2 m or longer; 2.3 m or longer; 2.4 m or longer; 2.5 m or longer; 2.6 m or longer; 2.7 m or longer; 2.8 m or longer; 2.9 m or longer; or 3.0 m or longer.

Referring to FIG. 2B, one or more screws or keyhole (e.g., element 2) are found on the back side of the apparatus through which the apparatus can be assembled.

Referring to FIG. 2C, a configuration with multiple ports or connecting sockets can be found at the back side of the apparatus, including but not limited to a power connecting module for connecting power line to power supply system (e.g., element 3); a system switch (e.g., element 4), through which the system can be turned on after being connected to a power supply; a plurality of ports such as mini USB ports or USB 2.0 ports (e.g., element 5) for connecting mouse, keyboard, flash disk and mobile devices, and etc.; one or more network ports (e.g., element 6) such as Ethernet ports and phone line ports and wireless network modules such as Bluetooth modules and WiFi modules for connecting the apparatus to the Internet or other devises; and a main system switch (e.g., element 7) for re-starting or resetting the machine.

In some embodiments, apparatus 100 comprises a touch screen, which in combination with indicator device 1 and motion sensing device 20, responds to commands represented by physical movements. In some embodiments, physical movements made by the person can be tracked and converted into commands to selected regions on the touch screen. For example, a pressing motion made by a hand aiming at a particular region of the touch screen can be received as a command on the particular region. In some embodiments, the command allows the user to select a wearable item. In some embodiments, the command allows the user to browse a catalog of wearable items. In some embodiments, the command allows the user to launching an application that executes an action such as fitting a selected wearable item, quitting the fitting program, enlarging or decreasing an image, sending a selected image via email, starting/ending data collection, starting/ending system calibration, turning on and off the apparatus, printing a selected imagine, downloading information of a selected wearable item or a catalog of wearable items, or purchasing one or more selected wearable items.

In some embodiments, a plurality of wheels is attached to the base of apparatus 100 to provide mobility. In some embodiments, two wheels are provided. In some embodiments, three wheels are provided. In some embodiments, three wheels are provided.

### Data Collecting, Processing and Content Management

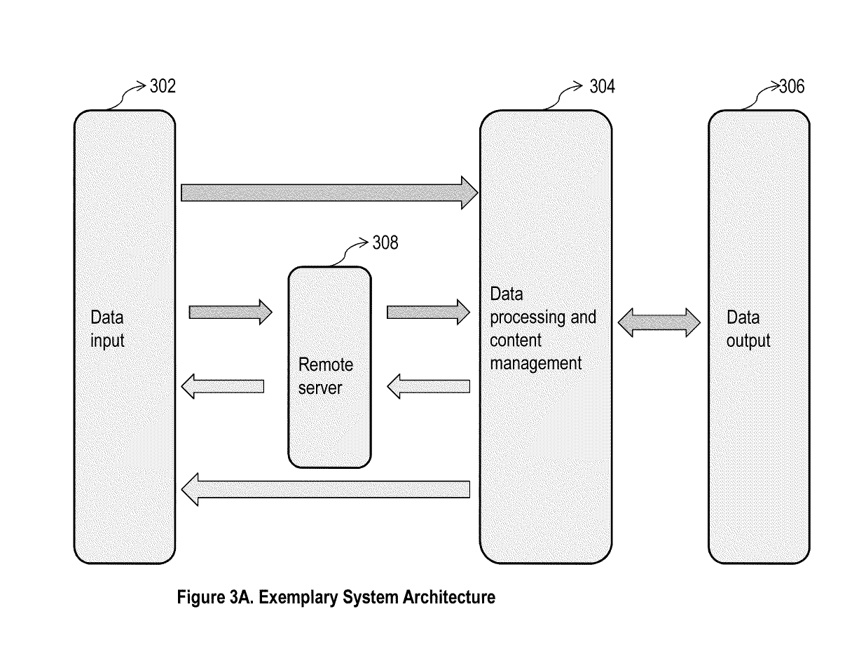

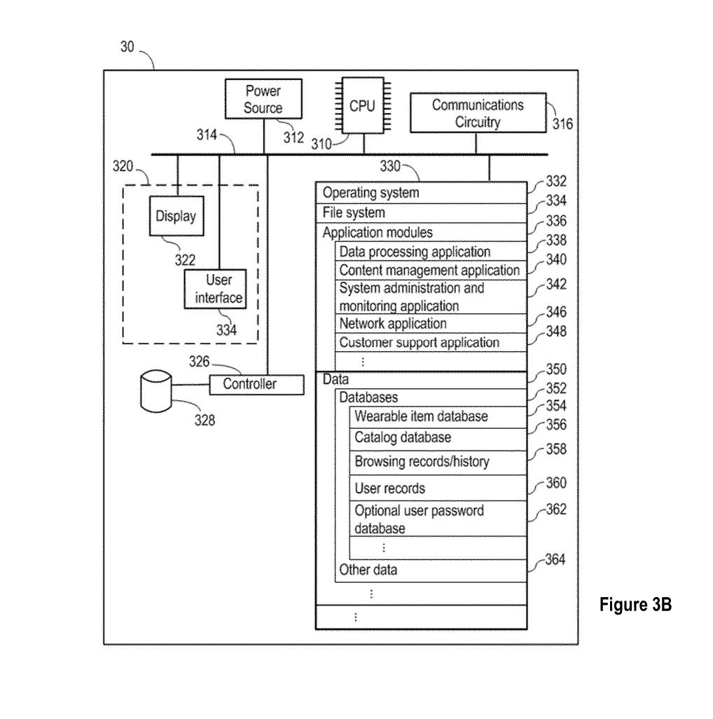

FIG. 3A illustrates an exemplary system architecture. FIG. 3B illustrates an exemplary computer system that supports an apparatus 100. In one aspect, the main components include a data input unit 302; a data processing unit 304; and a data output unit 306. In some embodiments, the system architecture also includes a remote server 308.

Any computer that is designated to run one or more specific server applications can be used as the remote server disclosed herein. In some embodiments, the remote server comprises one or more servers. In other embodiments, the remote server comprises one server. In certain embodiments, the remote server comprises two or more servers. In further embodiments, each of the two or more servers independently runs a server application, which may be the same as or different from applications running in the other servers.

The remote server may comprise or may be any computer that is configured to connect to the internet by any connection method disclosed herein and to run one or more server applications known to a skilled artisan. The remote server may comprise a mainframe computer, a minicomputer or workstation, or a personal computer.

In some embodiments, data input unit 302 includes an image collecting device 10 and a motion sensing device 20. In some embodiments, data input unit 302 further includes a manual input component through which a user can enter information such as height, weight, size and body type.

In some embodiments, data collected at data input unit 302 (referred to as raw data interchangeably) is transferred locally to data processing unit 304. In some embodiments, data collected at data input unit 302 is transferred first to a remote data server 308 before being transferred from the remote server to data processing unit 304.

In some embodiments, data collected at data input unit 302, e.g., digital images or scanning images, are processed and converted to indicia representing one or more physical attributes of an object/person; for example, the size, shape, height of a customer. In some embodiments, the indicia can be used to create a physical representation of the object/person from which/whom the images are capture. In some embodiments, a 3-dimensional representation corresponding to the body type of the person is created.

In some embodiments, a database of different body types is included locally on apparatus 100. In some embodiments, the data collected are processed by data processing unit 304 to identify the body type of the person. In some embodiments, a database of different body types is included on remote server 308. In some embodiments, the data collected are processed by data processing on remote data server 308 to identify the body type of the person.

In some embodiments, the identified body type is checked against additional data collected at data input unit 302 to ensure accuracy. In some embodiments, the identified body type is further processed by a content management application (e.g., a matching application) and matched against one or more selected wearable items.

In some embodiments, the result from the matching process is sent to output unit 306 as an image; for example, of the person wearing the selected wearable item.

In some embodiments, multiple wearable items can be fitted on the same user. For example, the effects of combinations of multiple wearable items can be tested by virtually fitting multiple selected wearable items.

In some embodiments, images and motions are collected from more than one users so that virtually fitting can be performed on more than one users. In some embodiments, multiple wearable items can be fitted on multiple users. In some embodiments, at least one wearable item each can be fitted on two users. In some embodiments, at least two wearable items each can be fitted on two users.

This system can achieve apparel and accessories collocation. Users can wear outfit, accessories, handbags and jewelries all at one time. Selected products' information and Quick Response (QR) codes of the products can be shown on the upside of the screen. The QR codes are generated by the content management. Each of the QR code can include up to 128 characters. The characters can be combined in different ways to represent different information or functions, for example, a URL of a website offering one or more products, information for shopping discount, promotion information, discount coupons, rebates and the like. The information, discount coupons and rebates can be optionally printed out by a printer.

### Computer System

FIG. 3B illustrates an exemplary computer system 30 that supports the functionality described above and detailed in sections below. In some embodiments, the system is located on a remote and centralized data server. In some embodiments, the system is located on the apparatus (e.g., element 100 of FIG. 2A).

In some embodiments, computer system 30 may comprise a central processing unit 310, a power source 312, a user interface 320, communications circuitry 316, a bus 314, a controller 326, an optional non-volatile storage 328, and at least one memory 330.

Memory 330 may comprise volatile and non-volatile storage units, for example random-access memory (RAM), read-only memory (ROM), flash memory and the like. In preferred embodiments, memory 330 comprises high-speed RAM for storing system control programs, data, and application programs, e.g., programs and data loaded from non-volatile storage 328. It will be appreciated that at any given time, all or a portion of any of the modules or data structures in memory 330 can, in fact, be stored in memory 328.

User interface 320 may comprise one or more input devices 324, e.g., a touch screen, a virtual touch screen, a keyboard, a key pad, a mouse, a scroll wheel, and the like. It also includes a display 322 such as a LCD or LED monitor or other output device, including but not limited to a printing device. A network interface card or other communication circuitry 316 may provide for connection to any wired or wireless communications network, which may include the Internet and/or any other wide area network, and in particular embodiments comprises a telephone network such as a mobile telephone network. Internal bus 314 provides for interconnection of the aforementioned elements of computer system 30.

In some embodiments, operation of computer system 30 is controlled primarily by operating system 332, which is executed by central processing unit 310. Operating system 332 can be stored in system memory 330. In addition to operating system 332, a typical implementation system memory 330 may include a file system 334 for controlling access to the various files and data structures used by the present invention, one or more application modules 336, and one or more databases or data modules 350.

In some embodiments in accordance with the present invention, applications modules 336 may comprise one or more of the following modules described below and illustrated in FIG. 3B.

Data Processing Application 338. In some embodiments in accordance with the present invention, a data processing application 338 receives and processes raw data such as images and movements. In some embodiments, the raw data are delivered to and processed by remote data server 308.

The raw data, once received, are processed to extract the essential features to generate a representation representing one or more physical attributes of the user. In some embodiments, extraction of raw data is achieved using, for example, a hash function. A hash function (or hash algorithm) is a reproducible method of turning data (usually a message or a file) into a number suitable to be handled by a computer. Hash functions provide a way of creating a small digital “fingerprint” from any kind of data. The function chops and mixes (e.g., bit shifts, substitutes or transposes) the data to create the fingerprint, often called a hash value. The hash value is commonly represented as a short string of random-looking letters and numbers (e.g., binary data written in hexadecimal notation). A good hash function is one that yields few hash collisions in expected input domains. In hash tables and data processing, collisions inhibit the distinguishing of data, making records more costly to find. Hash functions are deterministic. If two hash values derived from two inputs using the same function are different, then the two inputs are different in some way. On the other hand, a hash function is not injective, e.g., the equality of two hash values ideally strongly suggests, but does not guarantee, the equality of the two inputs. Typical hash functions have an infinite domain (e.g., byte strings of arbitrary length) and a finite range (e.g., bit sequences of some fixed length). In certain cases, hash functions can be designed with one-to-one mapping between identically sized domain and range. Hash functions that are one-to-one are also called permutations. Reversibility is achieved by using a series of reversible “mixing” operations on the function input. If a hash value is calculated for a piece of data, a hash function with strong mixing property ideally produces a completely different hash value each time when one bit of that data is changed.

The ultimate goal is to create a unique representation representing one or more physical attributes of the user. As such, the harsh function is ultimately associated with a visual representation of one or more physical attributes of the user.

By applying computation techniques (e.g., hash functions), data processing application 338 turns raw data (e.g., images) into digital data: coordinates representing one or more physical attributes of the user. In some embodiments, the digitized data are stored locally on apparatus 100. In some embodiments, the digitized data are transferred and stored on remote data server 308 and used as templates or samples in future matching/fitting processes. In some embodiments, the raw data are also transferred stored on remote data server 308. In some embodiments, multiple sets of raw data are processed using more than one algorithm to create multiple representation of the user to ensure accuracy. In some embodiments, the multiple representations of the user are averaged to ensure accuracy.

Content Management Application 340. In some embodiments, content management application 340 is used to organize different forms of content files 352 into multiple databases, e.g., a wearable item database 354, a catalog database 356, a browsing history database 358, a user record database 360, and an optional user password database 362. In some embodiments, content management application 340 is used to search and match representation of the user with one or more selected wearable items.

The databases stored on centralized data server 308 comprise any form of data storage system including, but not limited to, a flat file, a relational database (SQL), and an on-line analytical processing (OLAP) database (MDX and/or variants thereof). In some specific embodiments, the databases are hierarchical OLAP cubes. In some embodiments, the databases each have a star schema that is not stored as a cube but has dimension tables that define hierarchy. Still further, in some embodiments, the databases have hierarchy that is not explicitly broken out in the underlying database or database schema (e.g., dimension tables are not hierarchically arranged). In some embodiments, the databases in fact are not hosted on remote data server 308 but are in fact accessed by centralized data server through a secure network interface. In such embodiments, security measures such as encryption is taken to secure the sensitive information stored in such databases.

System Administration and Monitoring Application 342. In some embodiments, system administration and monitoring application 342 administers and monitors all applications and data files on apparatus 100. In some embodiments, system administration and monitoring application 342 also administers and monitors all applications and data files on remote data server 308. In some embodiments, security administration and monitoring is achieved by restricting data download access from centralized data server 308 such that the data are protected against malicious Internet traffic. In some embodiments, system administration and monitoring application 342 uses more than one security measure to protect the data stored on remote data server 308. In some embodiments, a random rotational security system may be applied to safeguard the data stored on remote data server 308.

In some embodiments, system administration and monitoring application 342 communicates with other application modules on remote data server 308 to facilitate data transfer and management between remote data server 308 and apparatus 100.

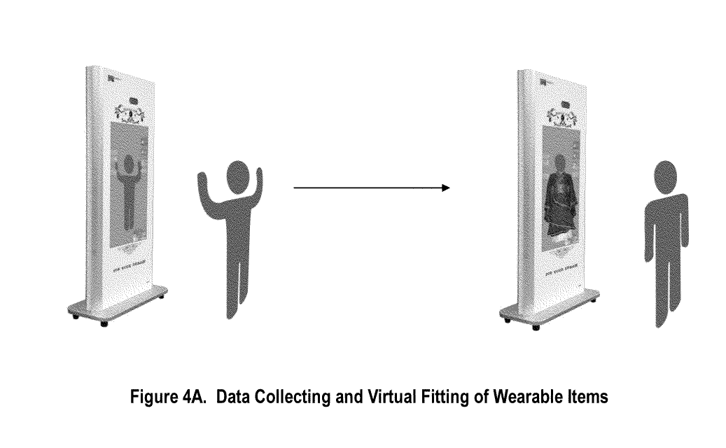

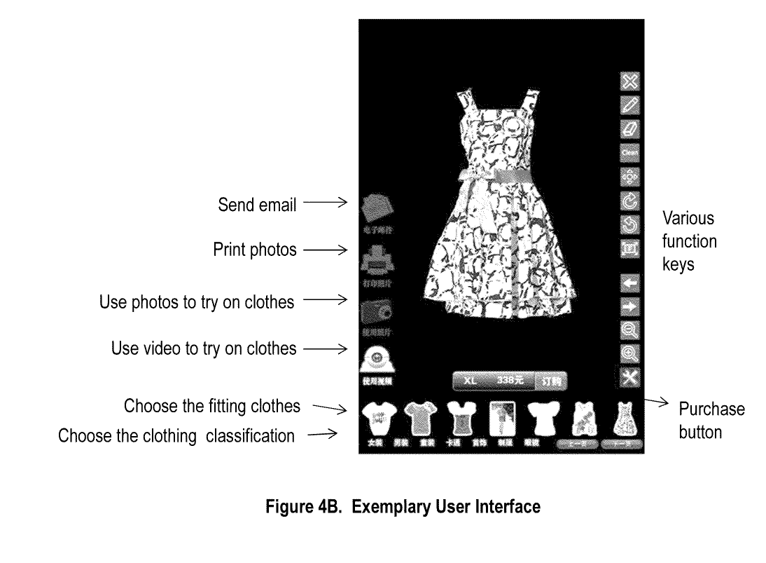

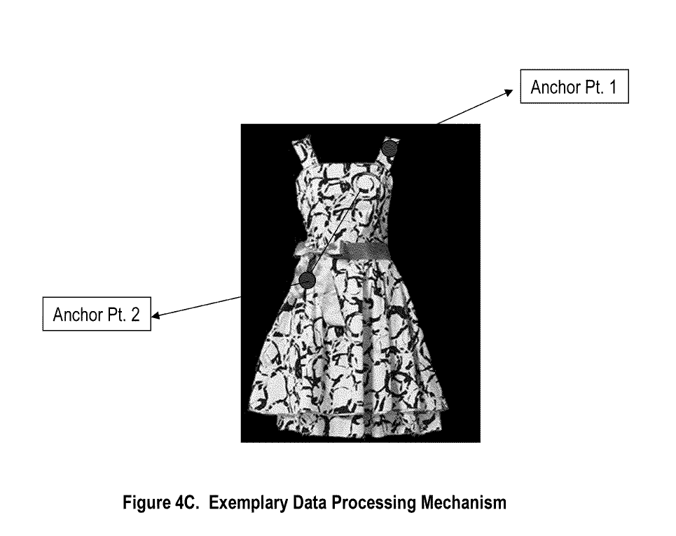

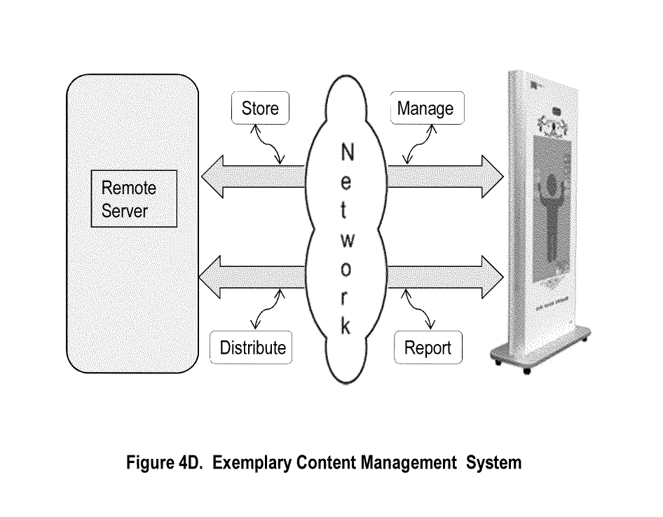

Network Application 346. In some embodiments, network application 346 connects a remote data server 308 with an apparatus 100. Referring to FIGS. 3A and 4D, remote data server 308 and apparatus 100 is connected to multiple types of gateway servers (e.g., a network service provider, a wireless service provider). These gateway servers have different types of network modules. Therefore, it is possible for network applications 346 on apparatus 100 and a remote data server 308 to be adapted to different types of network interfaces, for example, router based computer network interface, switch based phone like network interface, and cell tower based cell phone wireless network interface, for example, an 802.11 network or a Bluetooth network. In some embodiments, upon recognition, a network application 346 receives data from intermediary gateway servers before it transfers the data to other application modules such as data processing application 338, content management tools 340, and system administration and monitoring tools 342.

In some embodiments, network application 346 connects apparatus 100 with one or more mobile devices, including but not limited to personal digital assistants, cell phones, and laptop computers.

Customer Support Tools 348. Customer support tools 348 assist users with information or questions regarding their accounts, technical support, billing, etc. In some embodiments, customer support tools 348 may further include a lost device report system to protect ownership of user devices 10. When a user device 10 is lost, the user of the device can report to centralized data server 300 through customer support tools 348, for example, by calling a customer support number, through a web-based interface, or by E-mail. When a cell phone is reported lost or stolen, customer support tools 348 communicates the information to content management tools 340, which then searches and locates the synthesized security identifier 258 associated with the particular user device 10. In some embodiments, a request for authentication will be sent to user device 10, requiring that a biometric key be submitted to centralized data server 300. In some embodiments, if a valid biometric key is not submitted within a pre-determined time period, network access or any other services will be terminated for user device 10. In some embodiments, when user devices 10 are of high value, synthesized security identifier 258 and device identifier 254 (e.g., IPv6 address) may be used to physically locate the position of the alleged lost device.

In some embodiments, each of the data structures stored on apparatus 100 and/or remote data server 308 is a single data structure. In other embodiments, any or all such data structures may comprise a plurality of data structures (e.g., databases, files, and archives) that may or may not all be stored on remote data server 300. The one or more data modules 350 may include any number of content files 352 organized into different databases (or other forms of data structures) by content management tools 340:

In addition to the above-identified modules, data 350 may be stored on server 308. Such data comprises content files 352 and user data 360. Exemplary contents files 352 (device identifier database 354, user identifier database 356, synthesized security identifier database 358, and optional user password database 362) are described below.

Wearable Item Database 354. A wearable item database can include information (e.g., images, coordinates, sizes, colors and styles) of any wearable items disclosed herein.

Catalog Database 356. In some embodiments, a wearable item database 356 includes information of wearable items from the same vender. In some embodiments, a wearable item database 356 includes information of wearable items from multiple venders. In some embodiments, information on wearable item database 356 is organized into separate databases, each specialized in a particular type of wearable items; for example a hat database including information on all kinds of hats or a jewelry database including information on various kinds of jewelry items.

It is to be appreciated that a large number of databases, especially of wearable item database 356 from multiple venders, can be stored on remote data server 308 and can be accessed via network connection by apparatus 100. In some embodiments, data download from remote data server 300 is restricted to authorized retail store owners.

Browsing History Database 358. In some embodiments, browsing histories of a user can be saved in a preference file for the user. In some embodiments, browsing histories of multiple users are compiled to form browsing history database 358. Records in browsing history database 358 can be used to generate targeted advertisement of popular wearable items.

User Records Database 360. In some embodiments, user information, such as gender, body type, height, and shape can be compiled to form a user record database 360. Records in user record database 360 can also be used to generate advertisements of popular wearable items to specific groups of potential customers.

In some embodiments, databases on remote data server 308 or apparatus are distributed to multiple sub-servers. In some embodiments, a sub-server hosts identical databases as those found on remote data server 308. In some embodiments, a sub-server hosts only a portion of the databases found on remote data server 308. In some embodiments, global access to a remote data server 308 is possible for apparatuses 100 and mobile devices regardless of their locations. In some embodiments, access to a remote data server 308 may be restricted to only licensed retail store owners.

### Data Processing

Multiple applications are used to convert raw data, match wearable items to representation of body types of the user (e.g., FIGS. 4A-4D). Exemplary method for processing raw data has been illustrated.

An exemplary method for fitting/matching a selected wearable item on a representation of a user is illustrated in FIG. 4C. In some embodiments, a plurality of anchor points is defined on a selected wearable item. For example, two anchor points are defined for the dress depicted in FIGS. 4B and 4C, one anchor point is on one of the shoulder straps (e.g., left side) of the dress and the other anchor point is on the waist on the other side of the dress (e.g., right side). In some embodiments, more than two anchor points are defined; for example, three or more anchor points, four or more anchor points, five or more anchor points, six or more anchor points, seven or more anchor points, eight or more anchor points, nine or more anchor points, 10 or more anchor points, 12 or more anchor points, 15 or more anchor points, or 20 or more anchor points. More anchor points will lead to more accurate matching/fitting of the wearable item on the representation of the user. However, it will also slow down the matching/fitting process.

### Data and Content Management

As illustrated in FIGS. 3A and 4D, data and content can be transferred between apparatus 100 and remote data server 308. In some embodiments, information on wearable items can be stored locally on apparatus 100. In some embodiments, information on wearable items can be downloaded from remote data server 308 on demand using a network connection.

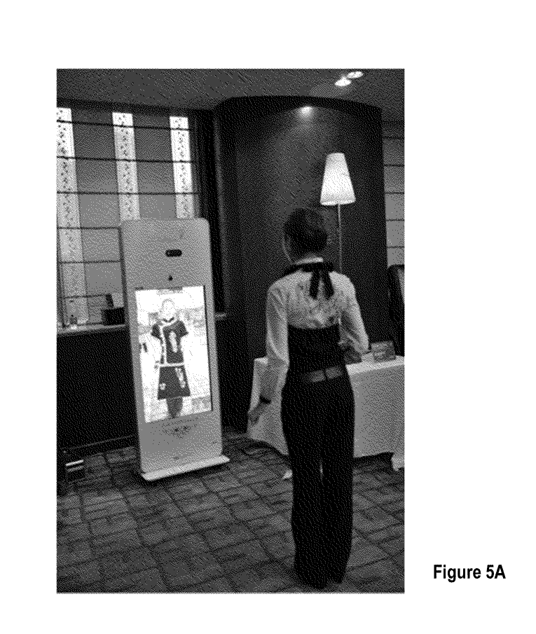

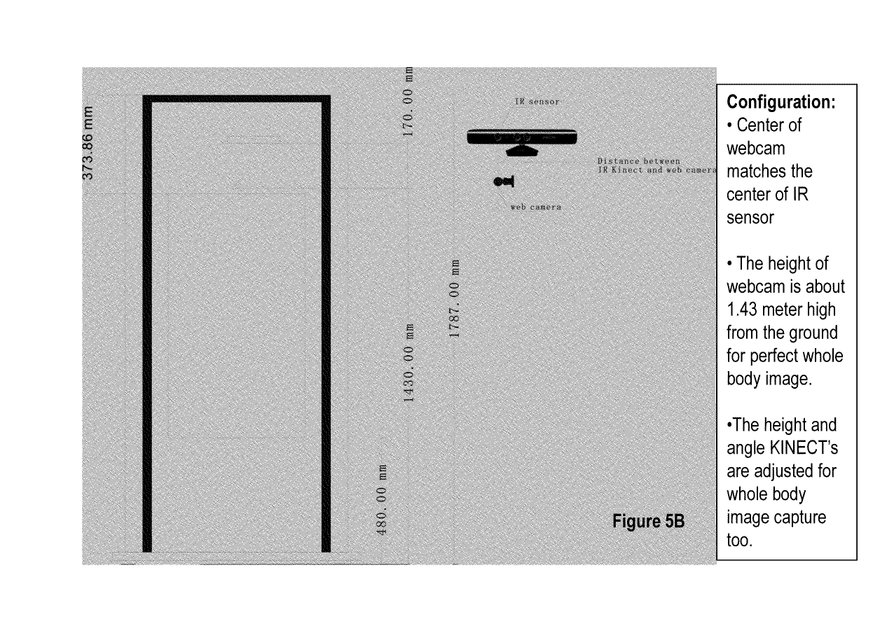

In some embodiments, the data and content include raw data collected by motion sensing device 20 and image collecting device 10. In some embodiments, the data and content include processed data, including fitted images (e.g., FIGS. 1 and 5A) and user profiles information.

### System Calibration

System calibration will be performed when mismatch or other errors are identified.

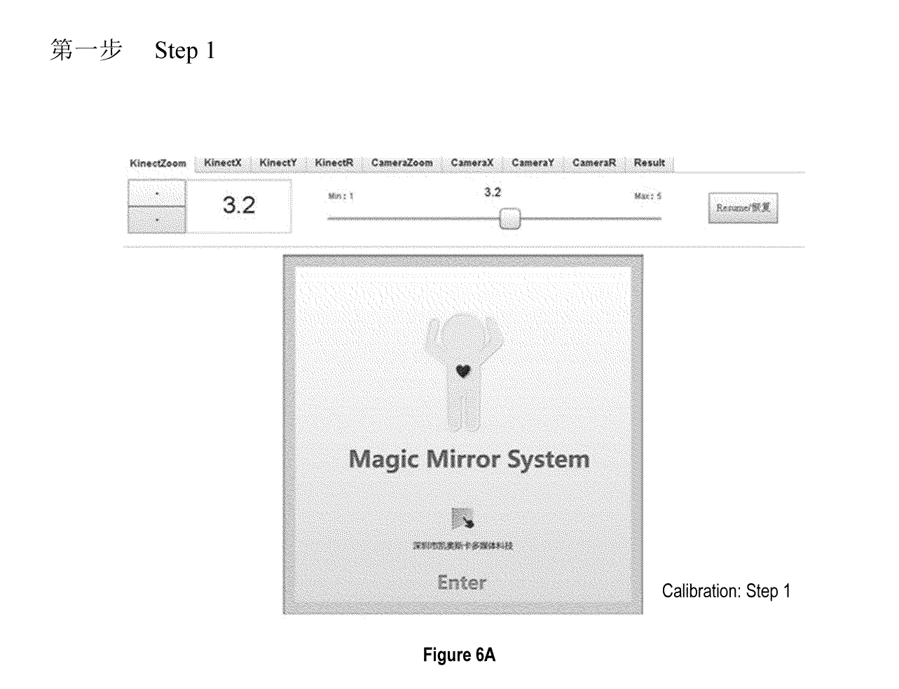

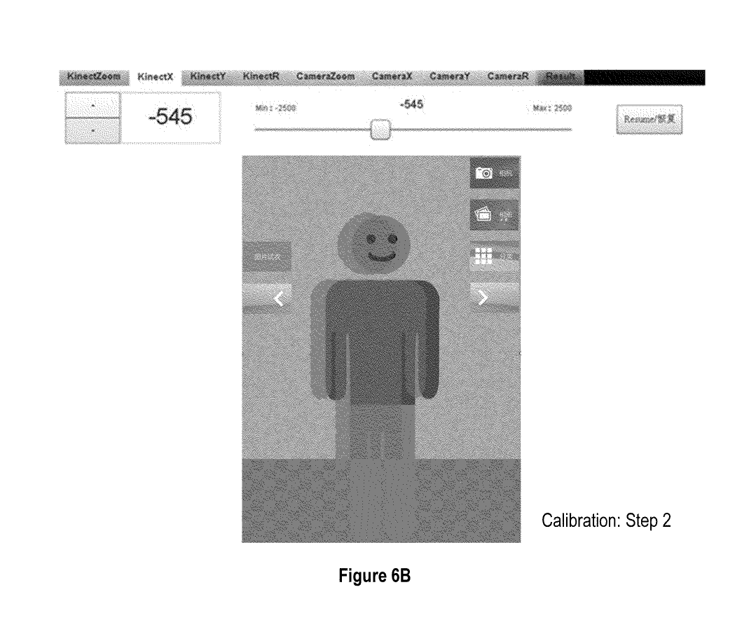

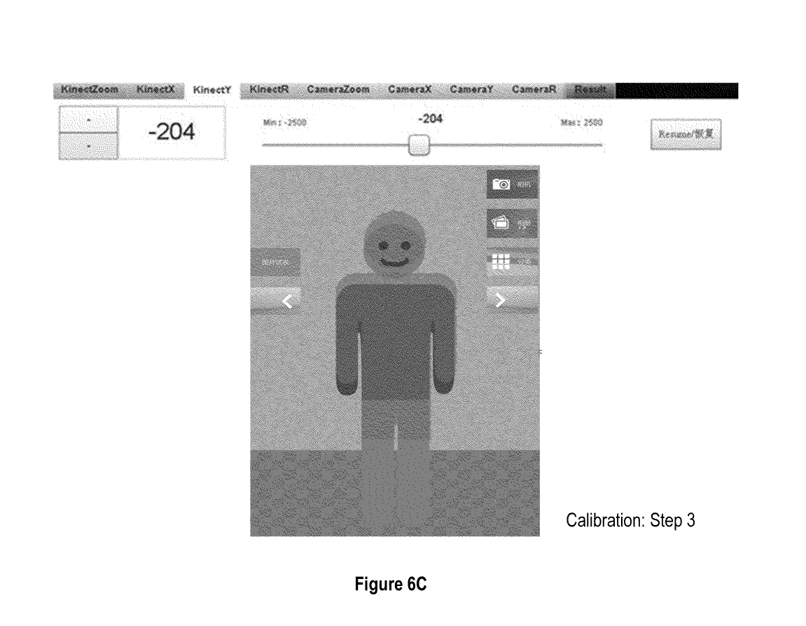

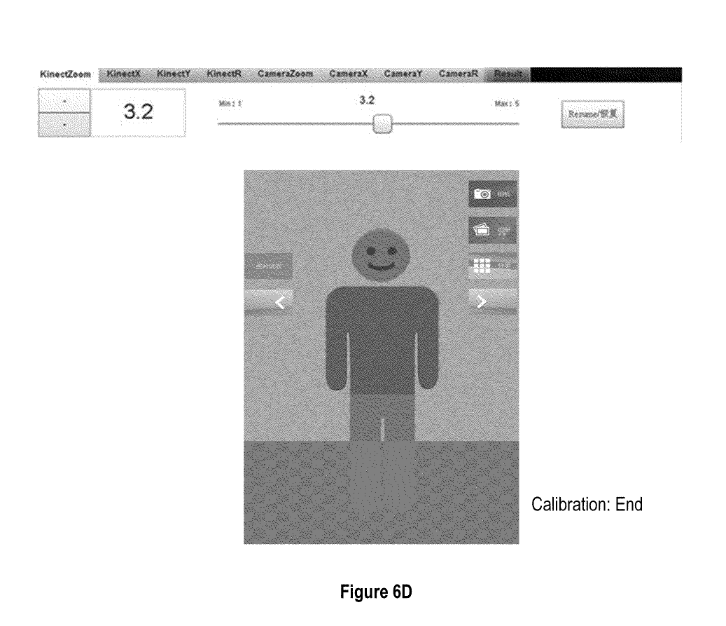

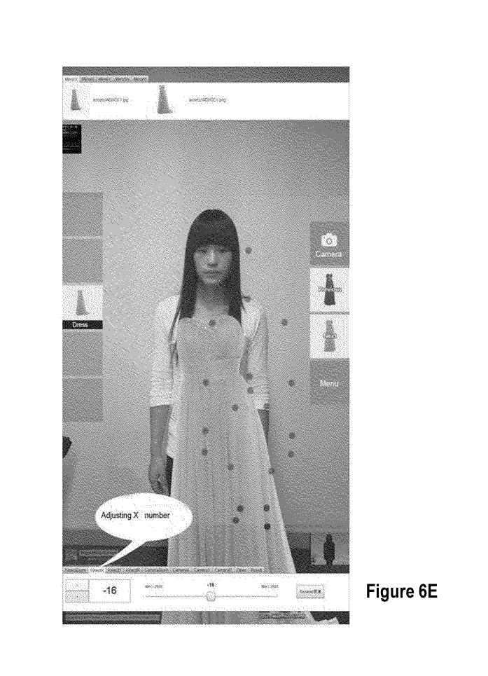

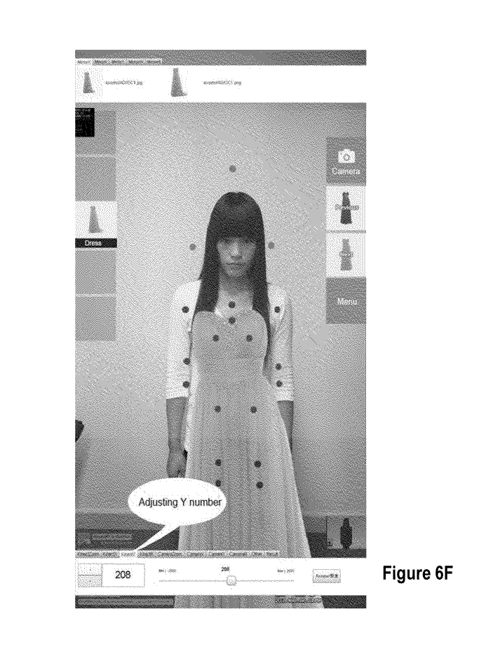

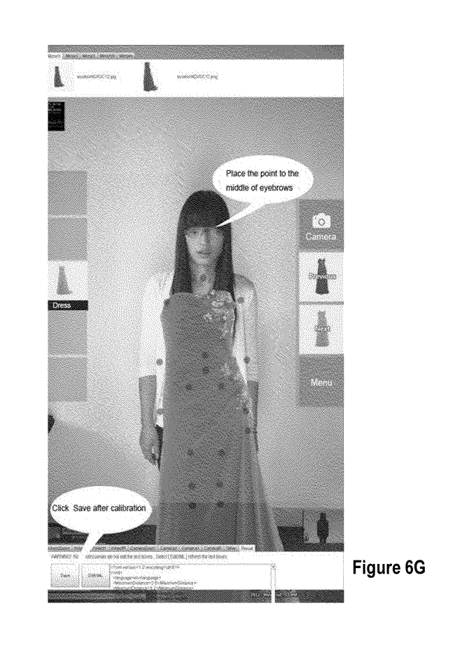

In some embodiments, when inaccurate results are found after a virtual fitting process, the apparatus can be calibrated; e.g., using the program adjustment function to adjust infrared sensor device; e.g., FIGS. 6A-6G.

In some embodiments, before launching a calibration program, computer keyboard and mouse are connected to the apparatus, for example, via the backend USB ports. In an exemplary calibration process, after a keyboard is connected, a command is provided to terminate the dressing/fitting program. In some embodiments, a calibration program is then launched. In some embodiments, launching of the calibration program and termination of the dressing/fitting program occur simultaneously. In some embodiments, system setup profile is de-protected to render it editable.

In some embodiments, calibration is achieved by matching an infrared image captured by the motion sensor device with the image capture by the HD camera. In some embodiments, the matching process takes place in two steps: a rough adjustment step followed by a fine adjustment step. In some embodiments, a mouse or the arrow keys on the computer keyboard are used to perform the adjustments. In some embodiments, a ruler is displayed during an adjustment process. The reading on the ruler corresponds to the discrepancy between the infrared image captured by the motion sensor device and the image capture by the HD camera. In some embodiments, adjustments can be performed in multiple directions; for example, along the x-axis or y-axis as indicated in FIGS. 6B and 6C. In some embodiments, adjustments along the x-axis are performed before adjustments along the y-axis. In some embodiments, adjustments along the y-axis are performed before adjustments along the x-axis.

A rule is used to guide the adjustment process. The ruler is turned on by right-clicking the mouse on the screen. The reading on the ruler corresponds to the discrepancy between the infrared image captured by the motion sensor device and the image capture by the HD camera. Adjustment is completed when the infrared image captured by the motion sensor device coincides with the image capture by the HD camera; e.g., FIG. 6D.

After adjustments, movements of the indicator bar in each direction are recorded and entered into the system setup file of the dressing/fitting program before the system setup file is protected again. In some embodiments, the system setup file is edited manually. In some embodiments, the system setup file is edited automatically. In some embodiments, a user is given a choice before editing the system setup file.

After the equipment infrared camera calibration, the dressing/fitting program is restarted for use.

In some embodiments, multiple data points (e.g., skeleton points) can be used for system calibration; see, e.g., FIGS. 6E-6G and Example 2.

In some embodiments, multiple rounds of calibration are performed to ensure accuracy before the system setup file is modified.

### Additional Functionalities and Features

Additional functionalities can be implemented, to perform actions including but not limited to browsing, purchasing, printing, and zooming in and out. In some embodiments, the program can focus on a particular body part of a user, such as a hand, eyes, ears when matching or fitting a piece of jewelry such as earrings, nose rings, necklaces, bracelets, and rings.

In some embodiments, apparatus 100 also includes an advertising functionality by which catalogs of wearable items can be displayed, accessed and browsed by a potential customer.

In some embodiments, certain parameters are adopted in order to achieve most optimal fitting effect. For example, the optimal distance between a user and the display component of a fitting/dressing device is between 1.5 to 2 meters.

However, one of skill in the art will understand that the distance changes with respect to the height and size of the user. For example, a young child may need to stand closer to the display, at a distance closer than 1.5 meters. While an adult basket player may need to stand at a distance greater than 2 meters.

In some embodiments, a user may need to adopt a certain pose to achieve the best effect for wearing a particular wearable item. For example, the user will need to hold his/her head in a certain position when trying on sunglasses and/or earrings. Also, for example, the user will need to hold his/her hand in a certain position when trying on handbags and/or bracelets.

In some embodiments, optimal dressing/fitting effects are achieved when the system is used by the same user throughout the dressing/fitting process; for example, no switching of user in the middle of a dressing/fitting process. In some embodiments, optimal dressing/fitting effects are achieved when the simultaneous presence of multiple users is avoided.

In some embodiments, optimal dressing/fitting effects are achieved when a static background is used. For example, a Japanese screen can be placed 3 meters away from screen to reduce interference.

In some embodiments, optimal dressing/fitting effects are achieved when a bright illumination is used on the user. In additional embodiments, a subdued light at a place of 1 meter away from screen also helps to optimize the dressing/fitting effects.

### Computer Program Products

The present invention can be implemented as a computer program product that comprises a computer program mechanism embedded in a computer readable storage medium. Further, any of the methods of the present invention can be implemented in one or more computers or computer systems. Further still, any of the methods of the present invention can be implemented in one or more computer program products. Some embodiments of the present invention provide a computer system or a computer program product that encodes or has instructions for performing any or all of the methods disclosed herein. Such methods/instructions can be stored on a CD-ROM, DVD, magnetic disk storage product, or any other computer readable data or program storage product. Such methods can also be embedded in permanent storage, such as ROM, one or more programmable chips, or one or more application specific integrated circuits (ASICs). Such permanent storage can be localized in a server, 802.11 access point, 802.11 wireless bridge/station, repeater, router, mobile phone, or other electronic devices. Such methods encoded in the computer program product can also be distributed electronically, via the Internet or otherwise, by transmission of a computer data signal (in which the software modules are embedded) either digitally or on a carrier wave.

Some embodiments of the present invention provide a computer program product that contains any or all of the program modules shown in FIGS. 3A, 3B, 4A-4D, 6A-6D and 7A-7H. These program modules can be stored on a CD-ROM, DVD, magnetic disk storage product, or any other computer readable data or program storage product. The program modules can also be embedded in permanent storage, such as ROM, one or more programmable chips, or one or more application specific integrated circuits (ASICs). Such permanent storage can be localized in a fitting apparatus, a server, 802.11 access point, 802.11 wireless bridge/station, repeater, router, mobile phone, or other electronic devices. The software modules in the computer program product can also be distributed electronically, via the Internet or otherwise, by transmission of a computer data signal (in which the software modules are embedded) either digitally or on a carrier wave.

### EXAMPLES

### Example 1

### Exemplary Virtual Fitting Apparatus

An exemplary apparatus (e.g., KMJ-42-L001 or KMJ-42-L002 of FIG. 5A) has a 42-inch liquid crystal display (LCD) at a resolution of 1080×1920. The display also functions as a 42-inch Infrared Touch Screen.

The overall apparatus has a height of about 1864 mm, a depth of about 110 mm, and width of about 658 mm; e.g., FIG. 5B. The foundation of the apparatus is about 400 mm by width. The center of the webcam is matched with the center of the infrared sensor device. In addition, the height of the webcam is about 1.4 meters (1.43 meters from the ground) for optimal whole body image capture. The height and angle of the KINECT™ device are adjusted for whole body image capture as well.

The apparatus is equipped with wheels for portability. Once a location is selected, the apparatus can be fixed at the selected using a brake-like module.

An exemplary apparatus also has the following features:
Infrared KINECT™ Controller
1080P HD Camera for capturing 3 million pixels static pictures
Screen: LED or projection
CPU: Intel™ Core 2 I5 or I7 series
RAM: 4 GB or 8 GB
Hard disk: 32 GB, SSD (64 GB, 128 GB, 320 GB, 500 GB also available) two USB 2.0 ports
High quality Stereo
Infrared sensor and deep sensor

The apparatus has printing capacity. A printing device can be connected via one of the USB ports.

The overall power consumption of the apparatus is 300 W. One of the adapted power supply is 220V and 50 hz. The machine can operate at a temperature between about 5° C. to about 40° C. (e.g., about 41 to 104° F.). The machine operates well at an absolute humidity: about 2-25 g H₂O/m³ and a relative humidity of about 5-80%.

This device combines hardware and software components with fashion enclosure. User just needs to connect the power supply. It is very easy for users.

A special editor is used to input images of wearable items. This special editor enables to input pictures, product information and generate (Quick Response) QR code etc.

### Example 2

### Exemplary Embodiments for System Operation and Calibration

The following illustrates an exemplary calibration process.

To start, a keyboard and/or a mouse are connected to one or more USB ports. After a keyboard is connected, a command such as “Ctrl+E” is provided to terminate the dressing program.

A user can then access system setup files on the hard disk of the apparatus; e.g., by entering a location the D drive using the path: “D:\ProgramFiles\koscar\MagicMirrorSystem\assets\Setup.xml.” The parameter of “Kinect_D_bug=‘0’” is located and modified to “Kinect_D_bug=‘1’” to render the program editable.

A “K” icon is located in “Start-Programs-Start” menu. Double click to open dressing program to enter adjust page. Infrared location and body size are then adjusted in KinectZooM page; e.g., FIG. 6A.

In Step 2 and step 3, KinectX and KinectY are adjusted such that the infrared image captured by the motion sensor device coincides with the image capture by the HD camera; e.g., FIGS. 6B and 6C. During the calibration process, a mouse or the arrow keys on the computer keyboard can be used to match the two types of images.

A rule is used to guide the adjustment process. The ruler is turned on by right-clicking the mouse on the screen. The reading on the ruler corresponds to the discrepancy between the infrared image captured by the motion sensor device and the image capture by the HD camera. In FIG. 6B, the discrepancy in the x-axis is indicated as −545, which can be adjusted by dragging/sliding the bar along the ruler. The left and right arrow keys on the computer keyboard can also be used to adjust the position of the indicator bar on the ruler.

In FIG. 6C, the discrepancy in the y-axis is indicated as −204, which can be adjusted by dragging/sliding the bar along the ruler. The upper and lower arrow keys on the computer keyboard can also be used to adjust the position of the indicator bar on the ruler.

Adjustment is completely when the infrared image captured by the motion sensor device coincides with the image capture by the HD camera; e.g., FIG. 6D.

After adjustments, movements of the indicator bar in each direction are recorded as values for the KinectX and KinectY parameters. Values in the system setup file are then changed accordingly: “KinectXNum=‘−545’” and “KinectYNum=‘−204’.” At last, a user modifies the “Kinect_D_bug=‘1’” field to “Kinect_D_bug=‘0’,” thus rendering the system file un-editable again. The system file is then saved and closed after the modification.

After the equipment infrared camera calibration, the dressing/fitting program is restarted for use.

An alternative calibration process is depicted in FIGS. 6E-6G. Here, calibration is also triggered when a wearable item appears to be misplaced on a user. USB ports are used to connect to a keyboard and mouse for controlling a calibration program. There are also USB ports (e.g., near the power supply) for connecting to printer or other USB devices. Multiple dots (e.g., multiple skeleton points obtained by the body scanner) are used to represent the wearable item (e.g., a dress in FIG. 6E). Specifically, after a keyboard is connected to USB, the “Ctrl+A” command is used to open skeleton calibration function. The infrared image is adjusted to coincide with HD camera image and place the skeleton point between the eyebrows by adjusting KinectX and KinectY. The distance between the infrared image and HD camera image can be adjusted using a mouse or keys on a keyboard (e.g., the left and right direction keys).

In FIG. 6E, X position is adjusted such that the dress is moved onto the body of a user in the X-direction. In FIG. 6F, Y position is adjusted such that the dress is moved onto the body of a user in the Y-direction. For example, the top skeleton point is moved to the middle of the eyebrows (FIG. 6G).

The “Ctrl+R” command is used to restart the dressing program. The program can also be launched by using a mouse to click a designated icon.

The “Ctrl+E” command is used to close the dressing program. The program can also be closed by using a mouse to click a designated icon.

### Example 3

### Exemplary Motion Sensor System

An example of the motion sensor system or device is the Microsoft KINECT™ console. The KINECT™ sensor is a horizontal bar connected to a small base with a motorized pivot and is designed to be positioned lengthwise above or below the video display. The device features an RGB camera, depth sensor and multi-array microphone running proprietary software, which provides full-body 3D motion capture, facial recognition and voice recognition capabilities. Voice recognition was also made available. The KINECT™ sensor's microphone array enables acoustic source localization and ambient noise suppression.

The depth sensor consists of an infrared laser projector combined with a monochrome CMOS sensor, which captures video data in 3D under any ambient light conditions. The sensing range of the depth sensor is adjustable, and the KINECT™ software is capable of automatically calibrating the sensor based on gameplay and the player's physical environment, accommodating for the presence of furniture or other obstacles.

The KINECT™ software technology enables advanced gesture recognition, facial recognition and voice recognition. It is capable of simultaneously tracking up to six people, including two active players for motion analysis with a feature extraction of 20 joints per player. PrimeSense has stated that the number of people the device can “see” is only limited by how many will fit in the field-of-view of the camera.

KINECT™ sensor outputs video at a frame rate of 30 Hz. The RGB video stream uses 8-bit VGA resolution (640×480 pixels) with a Bayer color filter, while the monochrome depth sensing video stream is in VGA resolution (640×480 pixels) with 11-bit depth, which provides 2,048 levels of sensitivity. The KINECT™ sensor has a practical ranging limit of 1.2-3.5 meters (3.9-11 ft) distance. The area required to play KINECT™ is roughly 6 m², although the sensor can maintain tracking through an extended range of approximately 0.7-6 meters (2.3-20 ft). The sensor has an angular field of view of 57° horizontally and 43° vertically, while the motorized pivot is capable of tilting the sensor up to 27° either up or down. The horizontal field of the KINECT™ sensor at the minimum viewing distance of about 0.8 m (2.6 ft) is therefore about 87 cm (34 in), and the vertical field is about 63 cm (25 in), resulting in a resolution of just over 1.3 mm (0.051 in) per pixel. The microphone array features four microphone capsules and operates with each channel processing 16-bit audio at a sampling rate of 16 kHz.

### Example 4

### Exemplary Fitting Processes

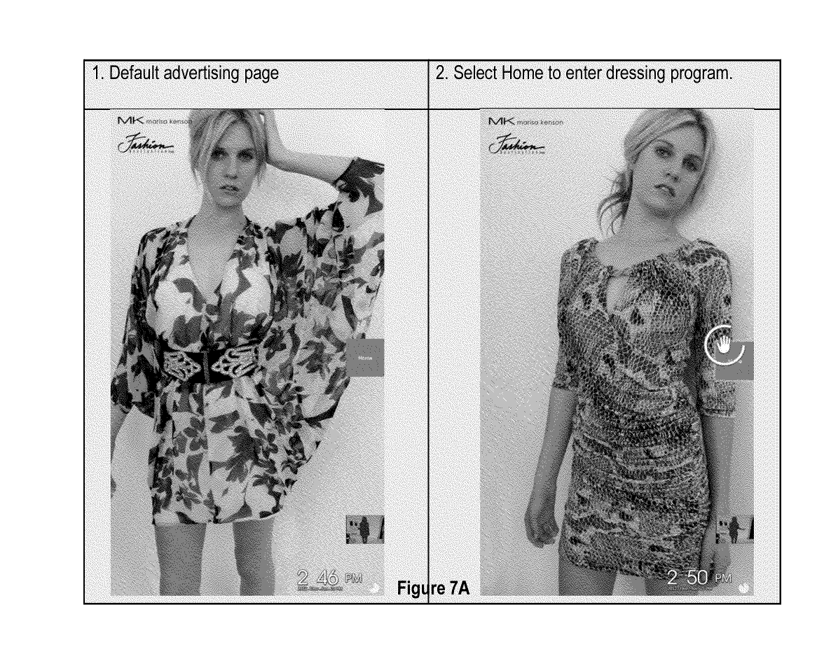

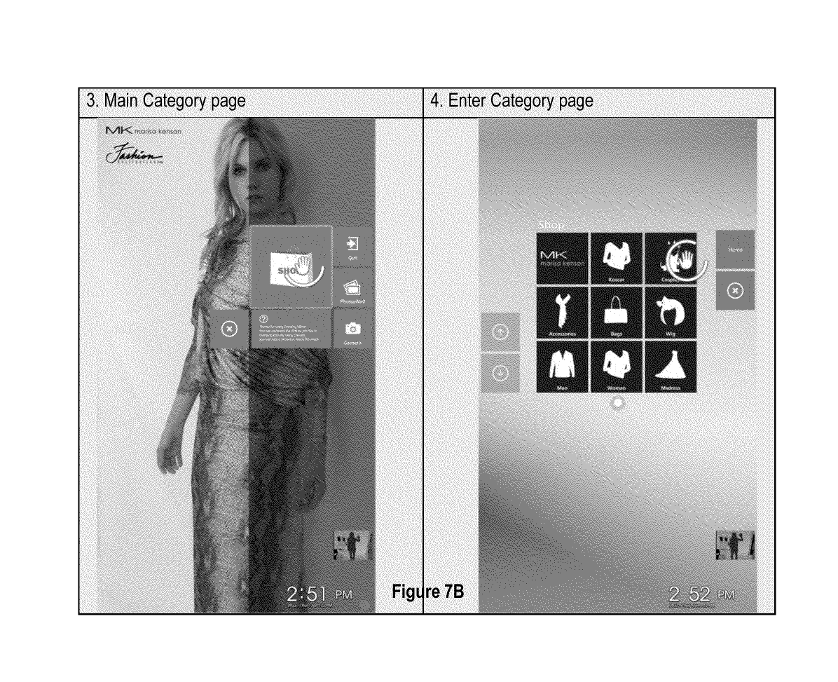

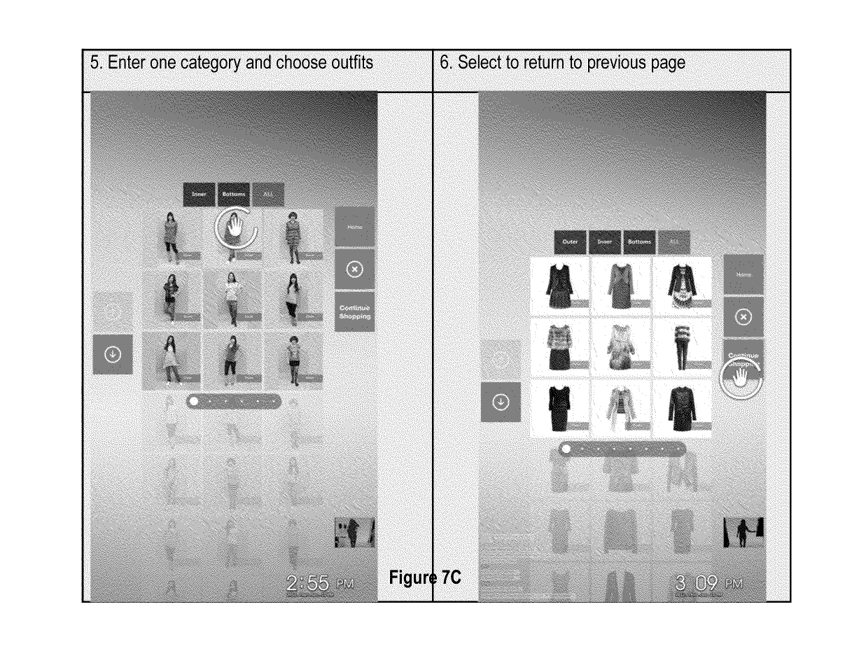

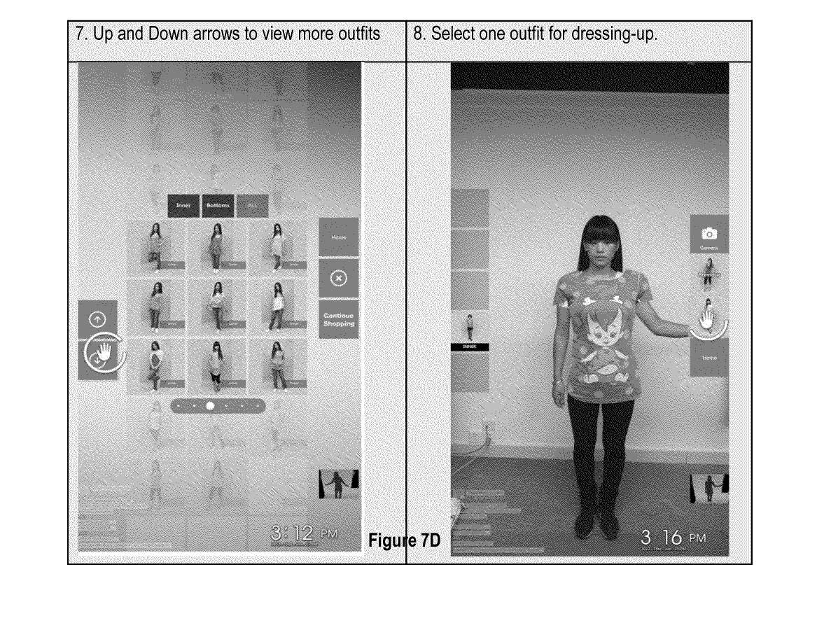

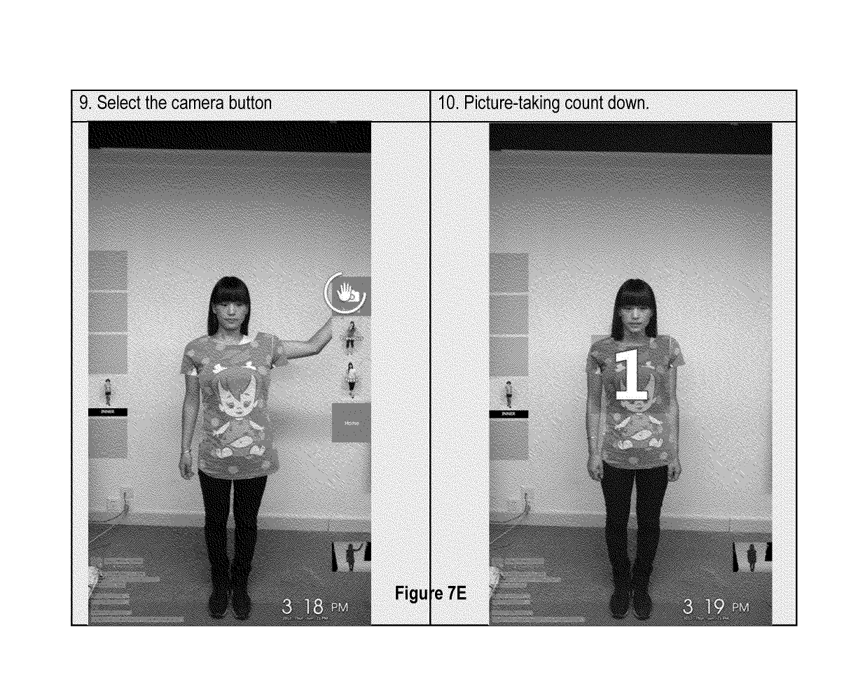

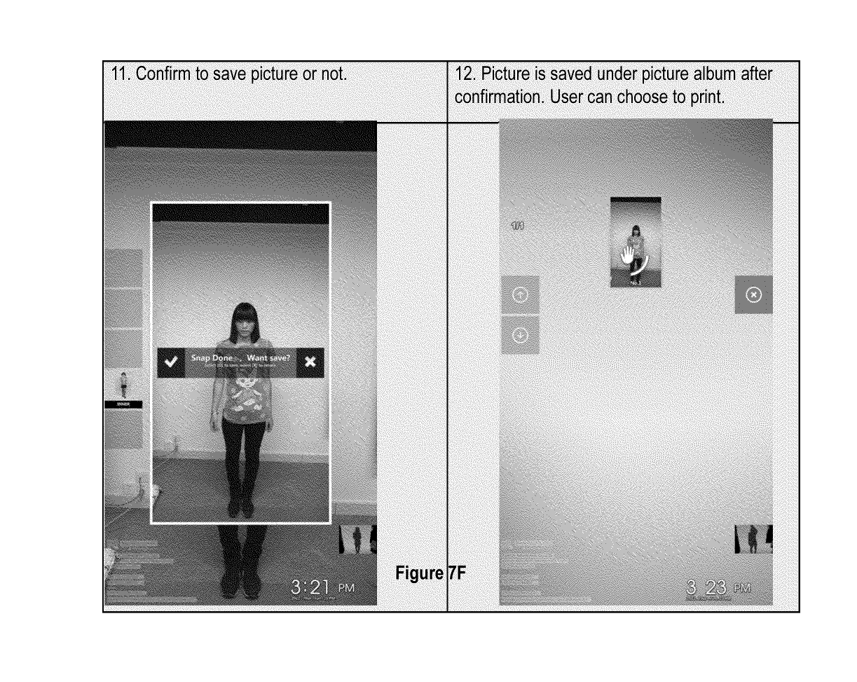

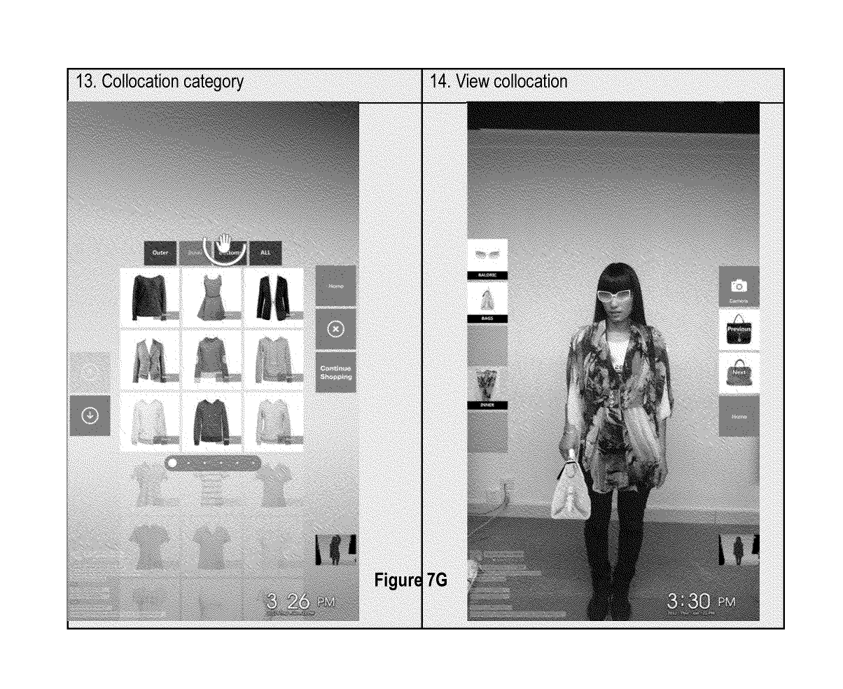

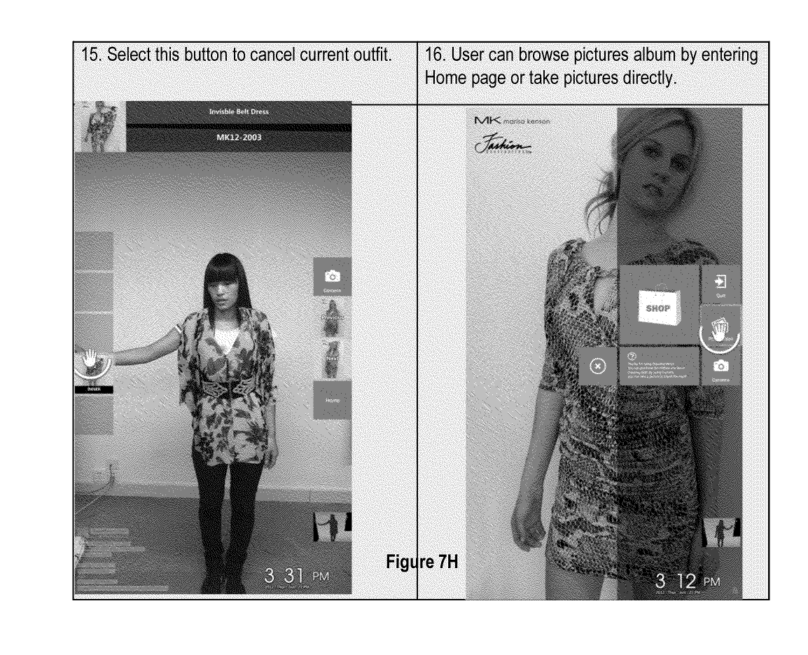

An exemplary fitting process is illustrated in detail in FIGS. 7A-7H. The process starts from a default advertising page (step 1). A user selects, from the advertising page or home page, to launch the dressing/fitting/matching program (step 2) and enters a main category page by selecting the Shop icon (step 3). Alternatively, the shop icon is presented on the home page and a user can directly enter the dressing/fitting/matching program by selecting the Shop icon (e.g., steps 2 and 3 are combined).

A number of categories of wearable items are offered at step 4. Once a user makes a selection, a number of wearable items within that category are displayed for the user to make further selection (step 5). Optionally, a user can select to return to a previous page (step 6) or browse through additional wearable items (step 7).

A matching/fitting process is launched when a wearable item is selected (step 8). The user can select the camera button to take image of the user fitted with a selected wearable item (steps 9 and 10).

The user can choose to save the image in a picture album and or print the image or take additional images (steps 11 and 12). A user can choose to display the photo before or after saving it in the picture album. The user can select to match/fit multiple wearable items using the collocation category function (steps 13 and 14).

A user can select to cancel an outfit (step 15). A user can choose to browse the picture album by going to the home page or launching the picture taking function (step 16).

Additional interfaces are introduced to link the store hosting the fitting device with other commercial entities. For example, a shopper introduction page can be displayed in addition to the category page shown in step 3 (FIG. 8A). In such an introduction page, additional commercial entities associated with the store where the device is located can be displayed. For example, a map of the shopping center or directories of the stores therein can be shown. In some embodiments, the stores displayed are related to the interests of the particular user (e.g., similar jewelry stores, similar handbag stores, or similar types of clothing stores).

The company information associated with a particular wearable item can also be displayed (e.g., FIG. 8B). For example, when printing out an image of the user wearing a particular wearable, the product information can also be printed, including the name of the company, contact information, and catalogue number associate with the wearable item.

### Example 5

### Additional Embodiments of Mode of Operation, User Control and Interface

There are two modes of operation for operating and controlling a device as described herein: 1) the device is operated and controlled by touchscreen mechanism; and 2) a user stands away from the device and controls the device by hand movements.

In the first mode of operation, the device operates similarly to a standard touchscreen device such as a mobile device or monitor.

In the second mode of operation, a typical dressing process includes: a user stands in from to the dressing/fitting device; the user raises one hand that will be displayed on a screen of the dressing device; Kinect movements of the hand will be recognized and tracked in the dressing process for moving or adjusting the positions of one or more wearable items.

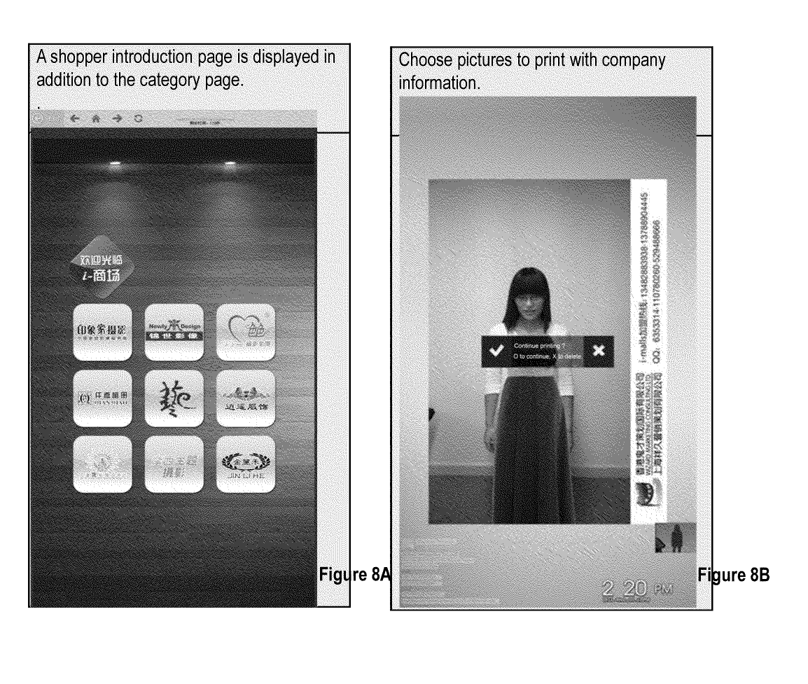

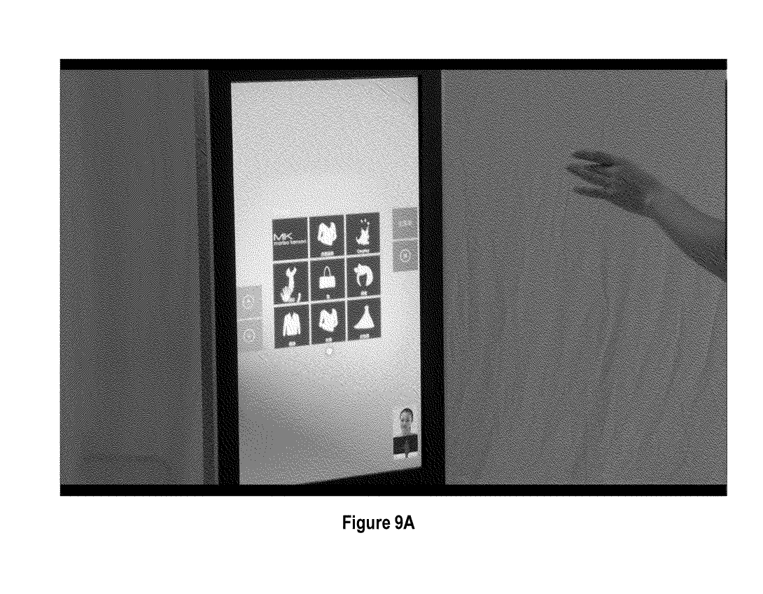

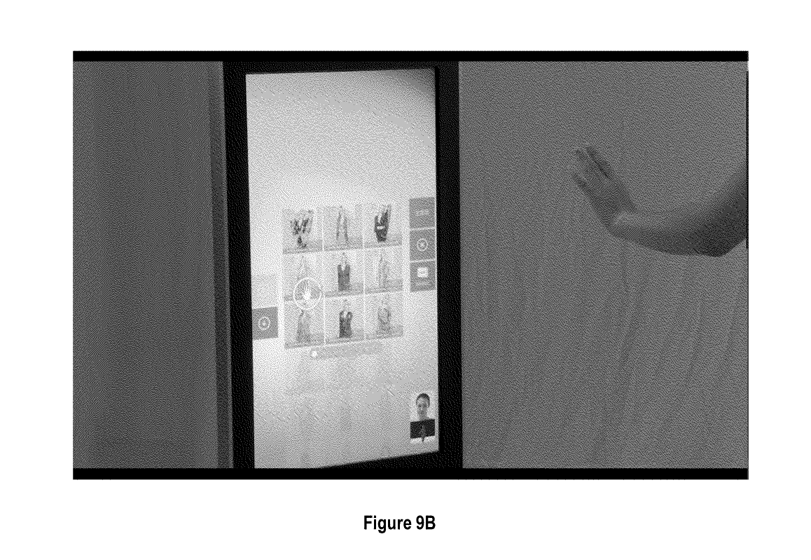

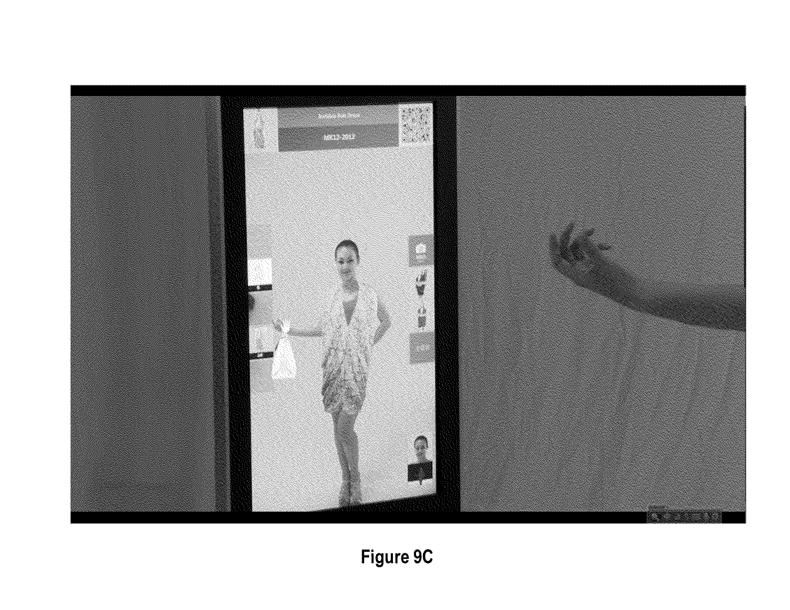

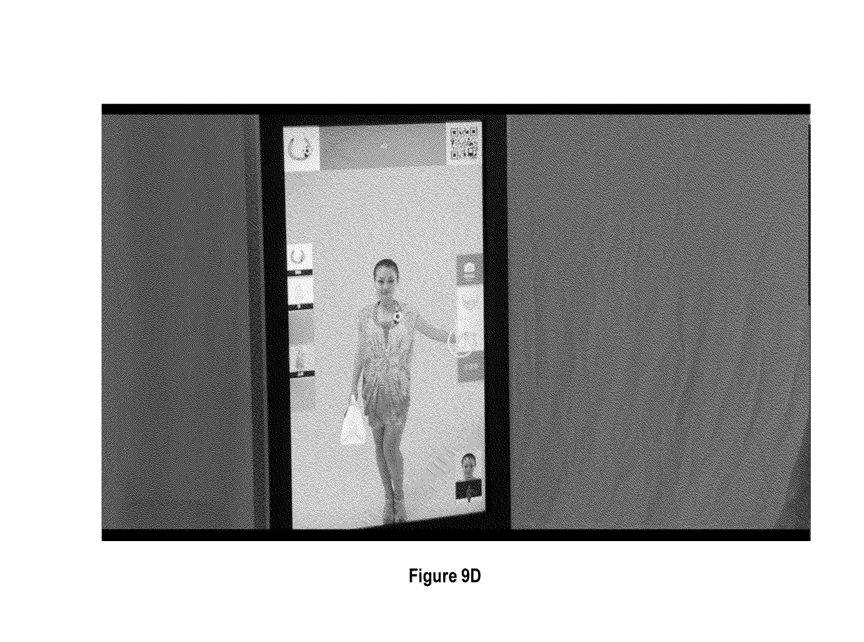

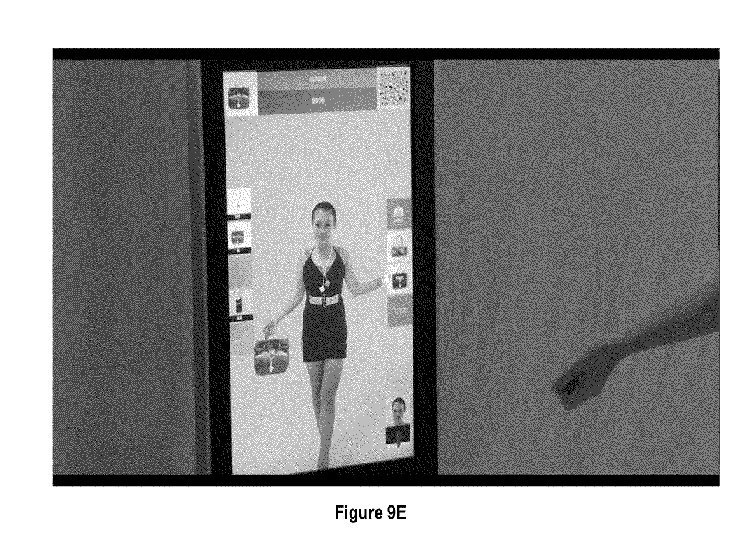

The fitting/dressing system can be targeted for a specific user. For example, the user interface depicted in FIG. 9A includes a user image at the bottom right corner, which indicates that the current system/program has been optimized for that specific user.

Referring to FIG. 9B, movements of either right or left hand can be used to control the user interface of a dressing/fitting program workable. In some embodiments, no command is accepted when both hands are raised.

Referring to FIGS. 9C through 9E, a handbag can be moved with hand positions. Once the user grabs the handbag, the handbag can be moved as the hand moves. The QR code of the wearable item and/or additional product information can be added to the user interface (UI); see for example, the top right corner of the screen in FIGS. 9C-9E. Icons on left side of the screens are for cancelling the fitting of the current wearable item. Icons on right side are for choosing additional wearable items.

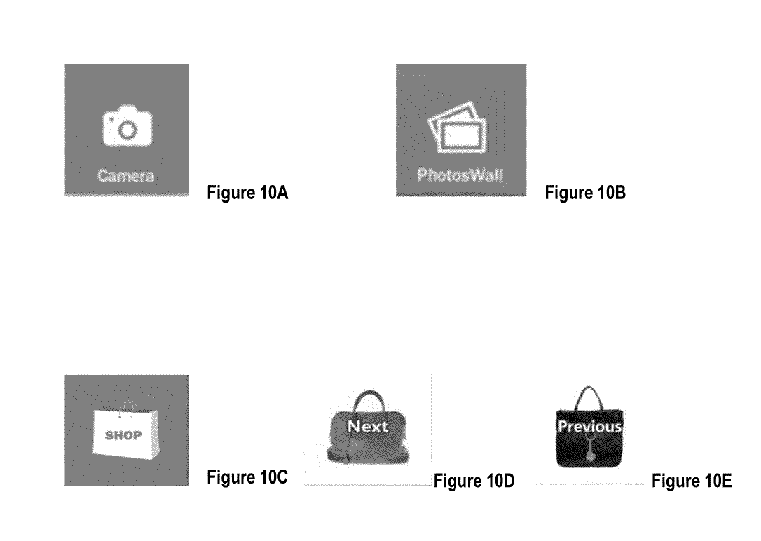

Exemplary icons that can be used in the user interface are illustrated in FIGS. 10A-10E. FIG. 10A shows a Cameron icon through which a user can take picture while wearing a wearing item. FIG. 10B shows a photo icon through which a user can save images to a photowall (e.g., one or more photo albums) and/or retrieve saved images for evaluation or printing. The Shop icon in FIG. 10C, when selected by hand motion, allows a user to choose a category of wearable items. The Next and Previous icons in FIGS. 10D and 10E allow a user to change/browse wearable items.

### Example 6

### Additional Embodiments for Jewelry Fitting

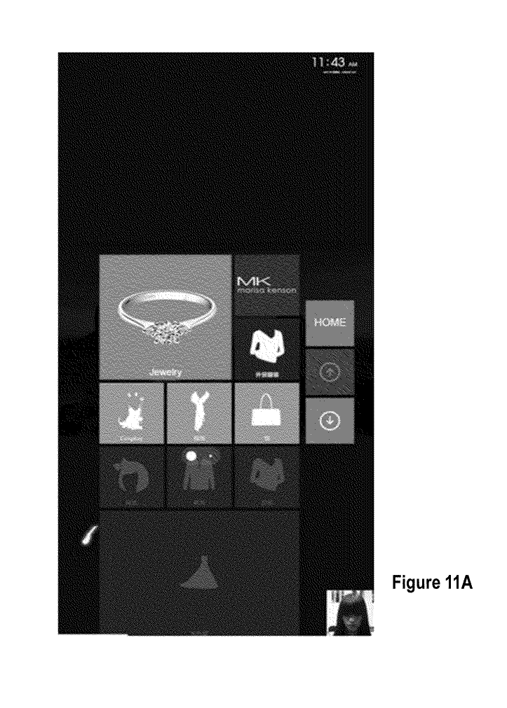

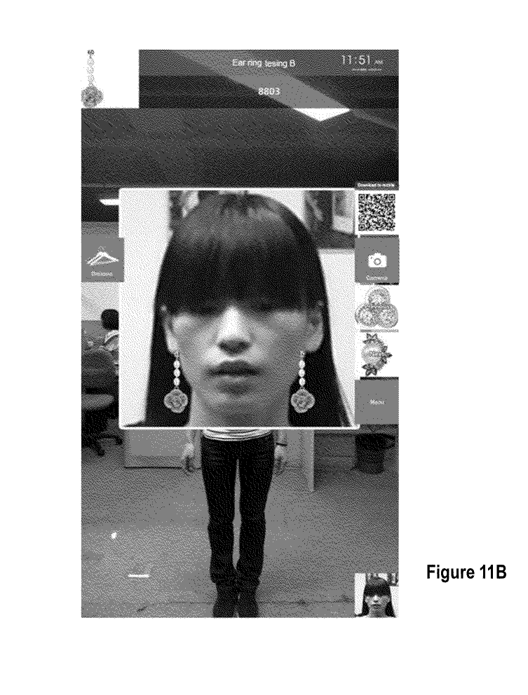

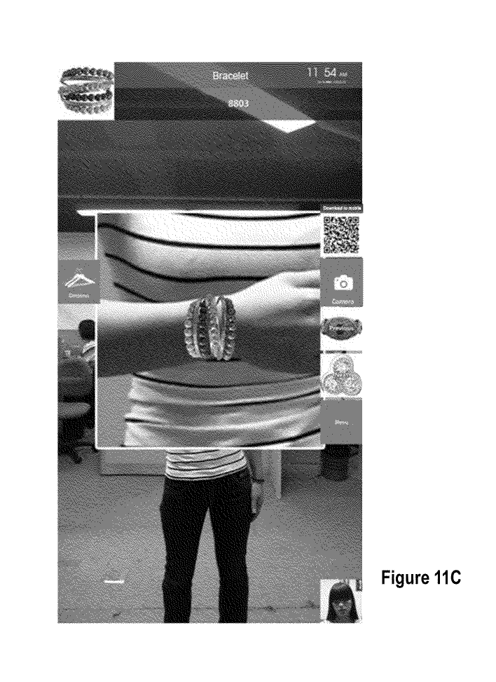

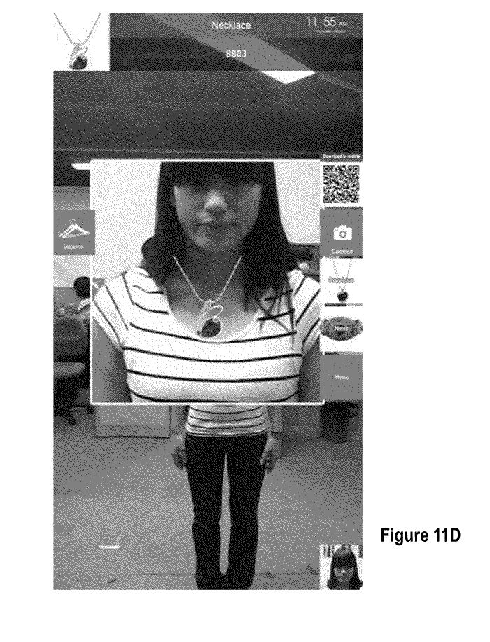

FIGS. 11A through 11D illustrate exemplary embodiments for fitting jewelry items. In the category interface, a user can select the icon representing jewelries (e.g., FIG. 10A). Once a specific jewelry item is selected, a particular part of the body will be magnified for better observation of the effect of wearing the jewelry item.

Referring to FIG. 11B, the head image of a user will be magnified (e.g., by 2.5×) when the user selects to try on one or more pairs of earrings.

Referring to FIG. 11C, the image of a hand of a user will be magnified (e.g., by 2.5×) when the user selects to try on one or more bracelets.

Referring to FIG. 11D, the image of a user's upper torso will be magnified (e.g., by 2.5×) when the user selects to try on one or more necklaces.

### INCORPORATION BY REFERENCE

All publications and patent applications mentioned in this specification are hereby incorporated by reference to the same extent as if each individual publication or patent application was specifically and individually indicated to be incorporated by reference, and as if each said individual publication or patent application was fully set forth, including any figures, herein.

What is claimed is:

1. An apparatus for virtually and interactively fitting at least one wearable item on a user, comprising:
a) a data input unit comprising:
a motion sensing device for tracking one or more movements of the user, and
an image collecting device for collecting one or more images of the user;
b) a data processing unit, wherein the data processing unit converts the one or more images to generate a representation corresponding to one or more physical attributes of the user, and wherein the data processing unit is capable of fitting a plurality of article coordinates representing the at least one wearable item to the representation corresponding to one or more physical attributes of the user to generate one or more fitted images of the user wearing the at least one wearable item; and
c) a data output unit comprising:
a display component, and
an optional printing component, wherein the display component displays the one or more fitted images of the user wearing the at least one wearable item and wherein the optional printing component is capable of printing the one or more fitted images on a print medium.

2. The apparatus of claim 1, wherein the motion sensing device also collects a plurality of physical measurements representing the one or more physical attributes of the user, and wherein the plurality of physical measurements is combined with the one or more images to generate the representation corresponding to the one or more physical attributes of the user.

3. The apparatus of claim 1, wherein the physical attributes comprise size, height, body type, shape, and distance from the motion sensing device.

4. The apparatus of claim 1, wherein the motion sensing device is selected from the group consisting of a Microsoft KINECT™ console, an infrared motion sensing device, an optical motion sensing device, and combinations thereof.

5. The apparatus of claim 1, wherein the image collecting device is selected from the group consisting of a camera, a digital camera, a web camera, a scanner, and combinations thereof.

6. The apparatus of claim 1, wherein the data input unit further comprises a manual input component that is capable of receiving manual input of additional physical measurements of the user, wherein the additional physical measurements are selected from the group consisting of size, height, weight, shape, body type, and combinations thereof.

7. The apparatus of claim 1, wherein the data processing unit further comprises a content management module for storing information of the at least one wearable items.

8. The apparatus of claim 1, wherein the at least one wearable item is selected from the group consisting of clothes, hats, wigs, eyeglasses, jewelry items, bags, scarves, head bands, shoes, socks, belts, ties, one or more clothes, one or more of hats, wigs, eyeglasses, jewelry items, bags, scarves, head bands, shoes, socks, belts, ties, and combinations thereof.

9. The apparatus of claim 1, wherein the at least one wearable item is selected from the group consisting of one or more clothes, one or more of hats, wigs, eyeglasses, jewelry items, bags, scarves, head bands, shoes, socks, belts, ties, and combinations thereof, wherein the jewelry items are selected from the group consisting of earrings, nose rings, necklaces, bracelets, rings and combinations thereof.

10. The apparatus of claim 1, wherein the display component is selected from the group consisting of digital light processing (DLP) displays, plasma display panels (PDPs), liquid crystal displays (LCDs), such as thin film transistor (TFT-LCD) displays and HPA-LCD displays, light-emitting diode (LED) displays, organic light-emitting diode (OLED) displays, electroluminescent displays (ELDs), surface-conduction electron-emitter displays (SEDs), field emission displays (FEDs), liquid crystal on silicon (LCOS or LCoS) displays, and interferometric modulator displays (IMODs), and combinations thereof.

11. The apparatus of claim 1, further comprising one or more USB ports, wherein the optional printing component is connected via a USB port.

12. A method for virtually and interactively fitting at least one wearable item on a user, comprising:
(a) collecting, via an image collecting device, one or more images of the user;
(b) tracking, via a motion sensing device, one or more movements of the user;
(c) converting, via a data processing unit, the one or more images to generate a representation representing one or more physical attributes of the user;
(d) fitting, via the data processing unit, a plurality of article coordinates representing the at least one wearable item to the representation representing one or more physical attributes of the user to generate one or more fitted images of the user wearing the at least one wearable item; and
(e) displaying, on a display component, the one or more fitted images of the user wearing the at least one wearable item.

13. The method of claim 12, further comprising:
printing, via a printing component, the one or more fitted images on a print medium.

14. The method of claim 12, wherein the tracking step further comprises:
collecting, via the motion sensing device, a plurality of physical measurements of the user, wherein the plurality of physical measurements and the one or more images are combined to generate a representation representing one or more physical attributes of the user.

15. The method of claim 12, further comprising:
inputting, via a manual input component, additional physical measurements of the user, wherein the additional physical measurements are selected from the group consisting of size, height, weight, shape, body type, and combinations thereof.

16. The method of claim 12, further comprising:
sending, to a remote data server, information of the at least one wearable item.

17. The method of claim 12, further comprising:
receiving, from a user, a command for collecting one or more images of the user or a command for tracking, one or more movements of the user.

18. The method of claim 12, further comprising:
communicating, to a remote data server, a request for information on one or more wearable items.

19. The method of claim 12, further comprising:
receiving, from a remote data server, information on one or more wearable items.

20. A computer program product that executes commands for performing the method of claim 12.
